(19) United States
(12) Patent Application Publication
(10) Pub. No.: US 2024/0228709 A1
(43) Pub. Date: Jul. 11, 2024

(54) GLASS REINFORCED RESIN MOLDED ARTICLE

(71) Applicant: NITTO BOSEKI CO., LTD., FUKUSHIMA-SHI, FUKUSHIMA (JP)

(72) Inventor: Yosuke NUKUI, FUKUSHIMA-SHI, FUKUSHIMA (JP)

(21) Appl. No.: 18/288,265

(22) PCT Filed: Mar. 28, 2022
(86) PCT No.: PCT/JP22/14938

§ 371 Date: Oct. 25, 2023

(30) Foreign Application Priority Data
May 31, 2021 (JP) 2021-090951

(51) Int. Cl. C08J 5/04; C08K 7/14

(52) U.S. Cl. CPC C08J 5/043; C08K 7/14; C08J 2300/22; C08J 2377/00; C08K 2201/004; C08K 2201/016

(57) ABSTRACT

A glass-reinforced resin molded article that enables the anisotropy of a shrinkage ratio and a TD direction shrinkage ratio to be reduced. The glass-reinforced resin molded article includes 10.0 to 90.0% by mass of a glass-reinforcing material and a thermoplastic resin, wherein the glass-reinforcing material includes flat cross-section glass fiber having a flat cross-sectional shape of which a ratio of a major axis to a minor axis is 3.0 to 10.0, a content C of the flat cross-section glass fiber is 10.0 to 80.0% by mass, the major axis D is 25.0 to 55.0 μm, a proportion P of glass-reinforcing material having a length of 50 to 100 μm with respect to the total number of glass-reinforcing material having a length of 50 μm or more is 4 to 50%, and the C, D, and P satisfy the following formula (1):

$$0.46 \leq P / {( C \times D )}^{1 / 2} \leq 0.99 . \qquad ( 1 )$$

### TECHNICAL FIELD

The present invention relates to a glass-reinforced resin molded article.

### BACKGROUND ART

Glass-reinforced resin molded articles comprising flat cross-section glass fiber having a flat cross-sectional shape have been conventionally known as glass-reinforcing materials (e.g., see Patent Literatures 1 and 2).

The glass-reinforced resin molded articles comprising flat cross-section glass fiber as a glass-reinforcing material are used in light, thin, short, and small parts such as portable electronic device cases since having suppressed occurrence of warpage and excellent dimensional stability and further having excellent mechanical physical properties, surface smoothness, and the like, in comparison with glass-reinforced resin molded articles comprising circular cross-section glass fiber having a circular cross-sectional shape. Here, as described in the Patent Literatures 1 and 2, in glass-reinforced resin molded articles comprising flat cross-section glass fiber, attempts of lengthening the fiber length of the flat cross-section glass fiber included in the glass-reinforced resin molded articles have been made in order to improve the mechanical physical properties.

### CITATION LIST

### Patent Literature

Patent Literature 1: Japanese Patent Laid-Open No. 2015-105359
Patent Literature 2: Japanese Patent Laid-Open No. 2010-222486

### SUMMARY OF INVENTION

### Technical Problem

As size reduction in electronic devices has further proceeded in recent years, glass-reinforced resin molded articles to be used as parts therefor also have been required to have higher dimensional accuracy.

In order to achieve this high dimensional accuracy, however, a glass-reinforced resin molded article comprising conventional flat cross-section glass fiber has a disadvantage in that the anisotropy of a shrinkage ratio, which is represented by the ratio of a molded article shrinkage ratio in the MD direction (hereinafter, referred to as the MD direction shrinkage ratio) with respect to the molded article shrinkage ratio in the TD direction (hereinafter, referred to as the TD direction shrinkage ratio), is large and particularly the value of the TD shrinkage ratio cannot be made sufficiently small.

The TD direction here is a direction that orthogonally intersects the flow direction of a resin composition when a resin composition comprising a glass-reinforcing material is molded to produce a glass-reinforced resin molded article. Moreover, the MD direction is the flow direction of a resin composition when a resin composition comprising a glass-reinforcing material is molded to produce a glass-reinforced resin molded article.

An object of the present invention is to eliminate the disadvantage to provide a glass-reinforced resin molded article that enables the anisotropy of the shrinkage ratio to be reduced and additionally enables the TD direction shrinkage ratio to be reduced.

### Solution to Problem

The present inventors have made intensive studies on the reason why the anisotropy of the shrinkage ratio is large and the value of the TD direction shrinkage ratio cannot be made sufficiently small in a glass-reinforced resin molded article comprising conventional flat cross-section glass fiber. As a result, the present inventors have found that, in contradiction to conventional attempts, allowing the length distribution of a glass-reinforcing material in a glass-reinforced resin molded article to shift to the shorter direction enables the anisotropy of the shrinkage ratio to be reduced and additionally enables the TD direction shrinkage ratio to be reduced, having completed the present invention.

That is, the glass-reinforced resin molded article of the present invention is a glass-reinforced resin molded article comprising a glass-reinforcing material in the range of 10.0 to 90.0% by mass and a thermoplastic resin in the range of 90.0 to 10.0% by mass, with respect to the total amount of the glass-reinforced resin molded article, wherein the glass-reinforcing material comprises flat cross-section glass fiber having a flat cross-sectional shape of which the ratio of the major axis to the minor axis (major axis/minor axis) is in the range of 3.0 to 10.0, the content C of the flat cross-section glass fiber with respect to the total amount of the glass-reinforced resin molded article is in the range of 10.0 to 80.0% by mass, the major axis D of the flat cross-section glass fiber is in the range of 25.0 to 55.0 μm, the proportion P of the glass-reinforcing material having a length in the range of 50 to 100 μm with respect to the total number of the glass-reinforcing material having a length of 50 μm or more included in the glass-reinforced resin molded article is in the range of 4 to 50%, and the C, D, and P satisfy the following formula (1):

$$0.46 \leq P / {( C \times D )}^{1 / 2} \leq 0 \text{.99} \qquad ( 1 )$$

When the glass-reinforced resin molded article of the present invention comprises the glass-reinforcing material and thermoplastic resin in the ranges, and the C, D, and P are in the ranges and satisfy the formula (1), the anisotropy of the shrinkage ratio can be reduced, and additionally the TD direction shrinkage ratio can be reduced.

The glass-reinforced resin molded article of the present invention can be obtained by, for example, kneading the glass-reinforcing material and the thermoplastic resin by a twin-screw kneader, and conducting injection molding using the obtained resin pellets. When the glass-reinforced resin molded article of the present invention is obtained by injection molding, the glass-reinforced resin molded article of the present invention can be expressed as a glass-reinforced resin injection molded article. The glass-reinforced resin molded article of the present embodiment can be obtained also by a known molding method such as injection compression molding method, two-color molding method, hollow molding method, foam molding method (including one using a supercritical fluid), insert molding method, in-mold coating molding method, extrusion molding method, sheet molding method, thermal molding method, rotational molding method, laminate molding method, press molding method, blow molding method, stamping molding method, infusion method, hand lay-up method, spray-up method, resin transfer molding method, sheet molding compound method, bulk molding compound method, pultrusion method, and filament winding method.

The MD direction shrinkage ratio and TD direction shrinkage ratio here can be determined as follows. When a flat plate is obtained by injection molding using a glass-reinforced resin composition constituting a glass-reinforced resin molded article and a mold having cavity inner dimensions of 80 mm in length, 60 mm in width, and 2.0 mm in depth, the MD direction shrinkage ratio is a numerical value calculated by (80−length direction actual dimension)/80×100, after the actual dimension in the length direction of the flat plate (length direction actual dimension; unit=mm) is measured with calipers. The TD direction shrinkage ratio is a numerical value calculated by (60−width direction actual dimension)/60×100 after the dimension in the width direction of the flat plate (width direction actual dimension; unit=mm) is measured with calipers.

Then, enabling the anisotropy of the shrinkage ratio to be reduced means that, when a flat plate glass-reinforced resin molded article of 2 mm in thick is produced as described above, the ratio of the MD direction shrinkage ratio to the TD direction shrinkage ratio (hereinafter, referred to as MD direction shrinkage ratio/TD direction shrinkage ratio) is 0.50 or more. Enabling the TD direction shrinkage ratio to be reduced means that, when a flat plate glass-reinforced resin molded article of 2 mm in thick is produced as described above, the ratio of the TD direction shrinkage ratio to the shrinkage ratio of the TD direction (reference shrinkage ratio) (hereinafter, referred to as TD direction shrinkage ratio/reference shrinkage ratio) of a glass-reinforced resin molded article is less than 0.70, which glass-reinforced resin molded article has been produced under the entirely same conditions except for using only circular cross-section glass fiber having a fiber diameter of 11.0 μm as the glass-reinforcing material and setting the screw rotation speed during kneading of the glass-reinforcing material and the resin to 100 rpm.

In the glass-reinforced resin molded article of the present invention, it is preferable that the C be in the range of 20.0 to 70.0% by mass, the D be in the range of 30.0 to 50.0 μm, the P be in the range of 10 to 40%, and the C, D, and P satisfy the following formula (2):

$$0.54 \leq P / {( C \times D )}^{1 / 2} \leq 0 \text{.72} \qquad ( 2 )$$

According to the glass-reinforced resin molded article of the present invention, when the C, D, and P are in the ranges and satisfy the formula (2), the anisotropy of the shrinkage ratio can be reduced and additionally the TD direction shrinkage ratio can be further reduced.

Enabling the TD direction shrinkage ratio to be further reduced here means that, when a flat plate glass-reinforced resin molded article of 2 mm in thick is produced, TD direction shrinkage ratio/reference shrinkage ratio is less than 0.60.

In the glass-reinforced resin molded article of the present invention, the flat cross-section glass fiber preferably having a flat cross-sectional shape of which the ratio of the major axis to the minor axis is in the range of 5.0 to 8.0.

The thermoplastic resin in the glass-reinforced resin molded article of the present invention is preferably one thermoplastic resin selected from the group of consisting of polycarbonate, polybutylene terephthalate, polyamide, or polyetheretherketone because of having an excellent balance among mechanical properties, heat resistance, dimensional accuracy, and material costs.

As the formula (2) is satisfied and the effects of the present invention become higher when a flat plate glass-reinforced resin molded article of 2 mm in thick is produced, the thermoplastic resin in the glass-reinforced resin molded article of the present invention is more preferably polycarbonate or polyamide.

When a flat plate glass-reinforced resin molded article of 2 mm in thick is produced, MID direction shrinkage ratio/TD direction shrinkage ratio becomes 0.60 or more, TD direction shrinkage ratio/reference shrinkage ratio becomes less than 0.50, and the effects of the present invention particularly become high. Thus, in the glass-reinforced resin molded article of the present invention, the thermoplastic resin is further preferably a polyamide.

### DESCRIPTION OF EMBODIMENTS

Hereinafter, embodiments of the present invention will be described in detail.

The glass-reinforced resin molded article of the present embodiment is a glass-reinforced resin molded article comprising a glass-reinforcing material in the range of 10.0 to 90.0% by mass and a thermoplastic resin in the range of 90.0 to 10.0% by mass, with respect to the total amount of the glass-reinforced resin molded article, wherein the glass-reinforcing material comprises flat cross-section glass fiber having a flat cross-sectional shape of which the ratio of the major axis to the minor axis (major axis/minor axis) is in the range of 3.0 to 10.0, the content C of the flat cross-section glass fiber with respect to the total amount of the glass-reinforced resin molded article is in the range of 10.0 to 80.0% by mass, the major axis D of the flat cross-section glass fiber is in the range of 25.0 to 55.0 μm, the proportion P of the glass-reinforcing material having a length in the range of 50 to 100 μm with respect to the total number of the glass-reinforcing material having a length of 50 μm or more included in the glass-reinforced resin molded article is in the range of 4 to 50%, and the C, D, and P satisfy the following formula (1):

$$0.46 \leq P / {( C \times D )}^{1 / 2} \leq 0.99 . \qquad ( 1 )$$

Here, as the P is larger, the anisotropy of the shrinkage ratio decreases, but the absolute value of the TD direction shrinkage ratio tends to deteriorate. As the C is larger, the value of the P becomes larger. In contrast, the absolute value of the TD direction shrinkage ratio decreases, but the anisotropy of the shrinkage ratio tends to deteriorate. As the D is larger, the value of the P tends to become larger. In contrast, the anisotropy of the shrinkage ratio decreases, and the absolute value of the TD direction shrinkage ratio also tends to decrease. The formula (1) is assumed to reflect these tendencies to represent the balance between a decrease in the anisotropy of the shrinkage ratio and a decrease in the absolute value of the TD direction shrinkage ratio.

The glass-reinforced resin molded article of the present embodiment can be obtained by, for example, kneading the glass-reinforcing material and the thermoplastic resin by a twin-screw kneader, and conducting injection molding using the obtained resin pellets.

In the glass-reinforced resin molded article of the present embodiment, as the glass-reinforcing material, for example, flat cross-section glass fiber, circular cross-section glass fiber, glass flake, glass powder, glass bead, and the like can be used.

The glass composition forming the flat cross-section glass fiber or circular cross-section glass fiber is not particularly limited. In the glass-reinforced resin molded article of the present embodiment, examples of the glass composition that may be taken by the glass fiber include the most common E glass composition, a high strength and high modulus glass composition, a high modulus and easily-producible glass composition, and a low dielectric constant and low dielectric tangent glass composition. From the viewpoint of improving the strength of the glass-reinforced resin molded article, the glass composition of the glass fiber is preferably the high strength and high modulus glass composition or the high modulus and easily-producible glass composition. From the viewpoint of lowering the dielectric constant and dielectric tangent of the glass-reinforced resin molded article and reducing the transmission loss of high frequency signals that pass through the glass-reinforced resin molded article, the glass composition of the glass fiber is preferably the low dielectric constant and low dielectric tangent glass composition.

The E glass composition is a composition including SiO2 in the range of 52.0 to 56.0% by mass, Al₂O₃ in the range of 12.0 to 16.0% by mass, MgO and CaO in the range of 20.0 to 25.0% by mass in total, and B₂O₃ in the range of 5.0 to 10.0% by mass, with respect to the total amount of the glass fiber.

The high strength and high modulus glass composition is a composition including SiO2 in the range of 60.0 to 70.0% by mass, Al₂O₃ in the range of 20.0 to 30.0% by mass, MgO in the range of 5.0 to 15.0% by mass, Fe₂O₃ in the range of 0 to 1.5% by mass, and Na₂O, K₂O, and Li₂O in the range of 0 to 0.2% by mass in total, with respect to the total amount of the glass fiber.

The high modulus and easily-producible glass composition is a composition including SiO2 in the range of 57.0 to 60.0% by mass, Al₂O₃ in the range of 17.5 to 20.0% by mass, MgO in the range of 8.5 to 12.0% by mass, CaO in the range of 10.0 to 13.0% by mass, and B₂O₃ in the range of 0.5 to 1.5% by mass, with respect to the total amount of the glass fiber, in which the total amount of SiO2, Al₂O₃, MgO, and CaO is 98.0% by mass or more.

The low dielectric constant and low dielectric tangent glass composition is a composition including SiO2 in the range of 48.0 to 62.0% by mass, B₂O₃ in the range of 17.0 to 26.0% by mass, Al₂O₃ in the range of 9.0 to 18.0% by mass, CaO in the range of 0.1 to 9.0% by mass, MgO in the range of 0 to 6.0% by mass, Na₂O, K₂O, and Li₂O in the range of 0.05 to 0.5% by mass in total, TiO, in the range of 0 to 5.0% by mass, SrO in the range of 0 to 6.0% by mass, F₂ and Cl₂ in the range of 0 to 3.0% by mass in total, and P₂O₅ in the range of 0 to 6.0% by mass, with respect to the total amount of the glass fiber.

Regarding measurement of the content of each component of the above glass compositions, the content of Li as the light element can be measured with an ICP emission spectroscopic analyzer, and the contents of other elements can be measured with a wavelength dispersive X-ray fluorescence analyzer. An example of the measurement method is as follows. The glass fiber is cut to an appropriate size, then placed in a platinum crucible and melted with stirring while being held at a temperature of 1550° C. for 6 hours in an electric furnace to obtain a homogeneous molten glass. When organic matter adheres to the surface of the glass fiber in cutting, or when glass fiber is mainly included as a reinforcing material in organic matter (resin), the glass fiber is used after the organic matter is removed by, for example, heating for about 2 to 24 hours in a muffle furnace at 300 to 650° ° C. Next, the obtained molten glass is poured onto a carbon plate to produce a glass cullet, and then pulverized and powdered to obtain glass powder. Regarding Li as a light element, the glass powder is thermally decomposed with an acid and then quantitatively analyzed using an ICP emission spectroscopic analyzer. Regarding other elements, the glass powder is molded into a disc shape by a pressing machine and then quantitatively analyzed using a wavelength dispersive X-ray fluorescence analyzer. For the quantitative analysis using a wavelength dispersive X-ray fluorescence analyzer, specifically, specimens for calibration curve are prepared based on the measurement results obtained by a fundamental parameter method, and the analysis can be performed by a calibration curve method. The content of each component in the specimens for calibration curve can be quantitatively analyzed by an ICP emission spectroscopic analyzer. These quantitative analysis results are converted in terms of oxides to calculate the content of each component and the total amount, and the above content (% by mass) of each component can be determined from these numerical values.

The glass fiber comprising the above glass composition is produced as follows. First, a glass raw material (glass batch) prepared to have the above composition is supplied to a melting furnace and melted at a temperature in the range of 1450 to 1550° C., for example. Then, the melted glass batch (melted glass) is drawn from 1 to 30000 nozzle tips of a bushing controlled at a predetermined temperature and rapidly cooled to form glass filaments. Subsequently, the glass filaments formed are applied with a sizing agent or binder using an applicator as an application apparatus. While 1 to 30000 of the glass filaments are bundled using a bundling shoe, the glass filaments are wound on a tube at a high speed using a winding apparatus to obtain glass fiber.

Here, allowing the nozzle tip to have a non-circular shape and to have a protrusion or a notch for rapidly cooling the molten glass and controlling the temperature conditions can provide flat cross-section glass fiber used in the glass-reinforced resin molded article of the present embodiment. Adjusting the diameter of the nozzle tip, winding speed, temperature conditions, and the like can adjust the minor axis and major axis of the glass fiber. For example, accelerating the winding speed can make the minor axis and major axis smaller, and reducing the winding speed can make the minor axis and major axis larger.

In the flat cross-section glass fiber, the flat cross-sectional shape is preferably a rectangular shape, an oval shape, or a long-oval shape, and more preferably a long-oval shape. Here, the cross-sectional shape, which is the shape of a cross section obtained by cutting at a face that orthogonally intersects the length direction of the glass fiber, the long-oval shape, which is a shape having a semicircular shape at both ends of a rectangle, or a shape similar thereto.

The glass fiber is usually formed by a plurality of glass filaments bundled, but in the glass-reinforced resin molded article, which is subjected to molding processing, the glass filaments are debundled and present dispersed in a glass filament state in the glass-reinforced resin molded article.

Here, examples of the preferred form of the flat cross-section glass fiber in the glass-reinforced resin molded article of the present embodiment before molding processing include chopped strands, in which the number of glass filaments constituting the glass fiber (number bundled) is preferably in the range of 1 to 20000, more preferably in the range of 50 to 10000, and further preferably in the range of 1000 to 8000, and the glass fiber (also referred to as a glass fiber bundle or glass strand) is preferably cut into a length in the range of 1.0 to 25.0 mm, further preferably in the range of 1.2 to 10.0 mm, particularly preferably in the range of 1.5 to 6.0 mm, and most preferably in the range of 2.5 to 3.5 mm. In addition, examples of the form of the glass fiber having a flat cross-sectional shape in the glass fiber-reinforced resin molded article of the present embodiment before molding processing include rovings, in which the number of glass filaments constituting the glass fiber is in the range of 10 to 30000 and which are obtained without cutting, and cut fiber, in which the number of glass filaments constituting the glass fiber is in the range of 1 to 20000 and which is obtained by pulverization so as to have a length of 0.01 to 1.00 mm by a known method such as a ball mill or Henschel mixer, in addition to chopped strands.

In the glass-reinforced resin molded article of the present embodiment, the glass fiber may be coated with an organic matter on the surface thereof for the purposes such as improvement of adhesiveness between glass fiber and a resin, and improvement of uniform dispersibility of glass fiber in a mixture of glass fiber and a resin or inorganic material. Examples of the organic matter include resins such as urethane resins, epoxy resins, vinyl acetate resins, acrylic resins, modified polypropylene, particularly carboxylic acid-modified polypropylene, and a copolymer of (poly)carboxylic acid, particularly maleic acid and an unsaturated monomer, or silane coupling agents.

In the glass-reinforced resin molded article of the present embodiment, the glass fiber may be coated with a composition including a lubricant, a surfactant, and the like, in addition to these resins or silane coupling agents. Such a composition covers the glass fiber at a rate of 0.1 to 2.0% by mass based on the mass of the glass fiber in a state where it is not coated with the composition.

The glass fiber can be coated with an organic matter by applying the sizing agent or the binder containing the solution of the resin, the silane coupling agent, or the composition to the glass fiber using a known method such as a roller applicator, for example, in the manufacturing process of the glass fiber and then drying the glass fiber to which the solution of the resin, the silane coupling agent, or the composition is applied.

Here, examples of the silane coupling agent include aminosilanes, chlorosilanes, epoxysilanes, mercaptosilanes, vinylsilanes, acrylsilanes, and cationic silanes. As the silane coupling agent, these compounds can be used singly or in combination of two or more.

Examples of the aminosilane include γ-aminopropyltriethoxysilane, N-β-(aminoethyl)-γ-aminopropyltrimethoxysilane, N-β-(aminoethyl)-N′-β-(aminoethyl)-γ-aminopropyltrimethoxysilane, and γ-anilinopropyltrimethoxysilane.

Examples of the chlorosilane include γ-chloropropyltrimethoxysilane.

Examples of the epoxysilane include γ-glycidoxypropyltrimethoxysilane and ß-(3,4-epoxy cyclohexyl)ethyltrimethoxysilane.

Examples of the mercaptosilane include γ-mercaptotrimethoxysilane.

Examples of the vinylsilane include vinyl trimethoxysilane and N-β-(N-vinylbenzylaminoethyl)-γ-aminopropyltrimethoxysilane.

Examples of the acrylsilane include γ-methacryloxypropyltrimethoxysilane.

Examples of the cationic silane include N-(vinylbenzyl)-2-aminoethyl-3-aminopropyltrimethoxysilane hydrochloride and N-phenyl-3-aminopropyltrimethoxysilane hydrochloride.

Examples of the lubricant include modified silicone oils, animal oils and hydrogenated products thereof, vegetable oils and hydrogenated products thereof, animal waxes, vegetable waxes, mineral waxes, condensates of a higher saturated fatty acid and a higher saturated alcohol, polyethyleneimine, polyalkylpolyamine alkylamide derivatives, fatty acid amides, and quaternary ammonium salts. As the lubricant, these can be used singly or in combinations of two or more.

Examples of the animal oil include beef tallow. Examples of the vegetable oil include soybean oil, coconut oil, rapeseed oil, palm oil, and castor oil.

Examples of the animal wax include beeswax and lanolin.

Examples of the vegetable wax include candelilla wax and carnauba wax.

Examples of the mineral wax include paraffin wax and montan wax.

Examples of the condensate of a higher saturated fatty acid and a higher saturated alcohol include stearates such as lauryl stearate.

Examples of the fatty acid amide include dehydrated condensates of polyethylenepolyamines such as diethylenetriamine, triethylenetetramine, and tetraethylenepentamine and fatty acids such as lauric acid, myristic acid, palmitic acid, and stearic acid.

Examples of the quaternary ammonium salt include alkyltrimethylammonium salts such as lauryltrimethylammonium chloride.

Examples of the surfactant include nonionic surfactants, cationic surfactants, anionic surfactants, and amphoteric surfactants. As the surfactant, these compounds can be used singly or in combination of two or more.

Examples of the nonionic surfactant can include ethylene oxide propylene oxide alkyl ether, polyoxyethylene alkyl ether, polyoxyethylene-polyoxypropylene-block copolymer, alkyl polyoxyethylene-polyoxypropylene block copolymer ether, polyoxyethylene fatty acid ester, polyoxyethylene fatty acid monoester, polyoxyethylene fatty acid diester, polyoxyethylene sorbitan fatty acid ester, glycerol fatty acid ester ethylene oxide adduct, polyoxyethylene castor oil ether, hydrogenated castor oil ethylene oxide adduct, alkylamine ethylene oxide adduct, fatty acid amide ethylene oxide adduct, glycerol fatty acid ester, polyglycerol fatty acid ester, pentaerythritol fatty acid ester, sorbitol fatty acid ester, sorbitan fatty acid ester, sucrose fatty acid ester, polyhydric alcohol alkyl ether, fatty acid alkanolamide, acetylene glycol, acetylene alcohol, ethylene oxide adduct of acetylene glycol, and ethylene oxide adduct of acetylene alcohol.

Examples of the cationic surfactant can include alkyldimethylbenzylammonium chloride, alkyltrimethylammonium chloride, alkyl dimethyl ethyl ammonium ethyl sulfate, higher alkylamine salts such as higher alkylamine acetate and higher alkylamine hydrochloride, adduct of ethylene oxide to a higher alkylamine, condensate of a higher fatty acid and polyalkylene polyamine, a salt of an ester of a higher fatty acid and alkanolamine, a salt of higher fatty acid amide, imidazoline cationic surfactant, and alkyl pyridinium salt.

Examples of the anionic surfactant can include higher alcohol sulfate salts, higher alkyl ether sulfate salts, α-olefin sulfate salts, alkylbenzene sulfonate salts, «-olefin sulfonate salts, reaction products of fatty acid halide and N-methyl taurine, dialkyl sulfosuccinate salts, higher alcohol phosphate ester salts, and phosphate ester salts of higher alcohol ethylene oxide adduct.

Examples of the amphoteric surfactant can include amino acid amphoteric surfactants such as alkali metal salts of alkylaminopropionic acid, betaine amphoteric surfactants such as alkyldimethylbetaine, and imidazoline amphoteric surfactants.

As the glass flake used in the glass-reinforced resin molded article of the present embodiment, a scaly one having a thickness of in the range of 1 to 20 μm and a length of one side in the range of 0.05 to 1 mm, for example, can be used. As the glass flake used in the glass-reinforced resin molded article of the present embodiment, one having a volume average particle size in the range of 0.5 to 20 μm, for example, can be used. As the glass bead to be used in the glass-reinforced resin molded article of the present embodiment, a spherical one having an outer diameter in the range of 10 to 100 μm, for example, can be used.

In the glass-reinforced resin molded article of the present embodiment, as the thermoplastic resin, polyethylene, polypropylene, polystyrene, styrene/maleic anhydride resins, styrene/maleimide resins, polyacrylonitrile, acrylonitrile/styrene (AS) resins, acrylonitrile/butadiene/styrene (ABS) resins, chlorinated polyethylene/acrylonitrile/styrene (ACS) resins, acrylonitrile/ethylene/styrene (AES) resins, acrylonitrile/styrene/methyl acrylate (ASA) resins, styrene/acrylonitrile (SAN) resins, methacrylic resins, polyvinyl chloride (PVC), polyvinylidene chloride (PVDC), polyamide, polyacetal, polyethylene terephthalate (PET), polybutylene terephthalate (PBT), polytrimethylene terephthalate (PTT), polycarbonate, polyarylene sulfide, polyethersulfone (PES), polyphenylsulfone (PPSU), polyphenylene ether (PPE), modified polyphenylene ether (m-PPE), polyaryl ether ketone, liquid crystal polymer (LCP), fluororesins, polyetherimide (PEI), polyarylate (PAR), polysulfone (PSF), polyamideimide (PAI), polyaminobismaleimide (PABM), thermoplastic polyimide (TPI), polyethylene naphthalate (PEN), ethylene/vinyl acetate (EVA) resins, ionomer (IO) resins, polybutadiene, styrene/butadiene resins, polybutylene, polymethylpentene, olefin/vinyl alcohol resins, cyclic olefin resins, cellulose resins, polylactic acid, and the like can be used. Polyamide, polycarbonate, polybutylene terephthalate, or polyaryl ether ketone can be preferably used, polyamide or polycarbonate can be more preferably used, and polyamide can be further preferably used.

Specific examples of the polyamide can include one of components such as polycaproamide (polyamide 6), polyhexamethylene adipamide (polyamide 66), polytetramethylene adipamide (polyamide 46), polytetramethylene sebacamide (polyamide 410), polypentamethylene adipamide (polyamide 56), polypentamethylene sebacamide (polyamide 510), polyhexamethylene sebacamide (polyamide 610), polyhexamethylene dodecamide (polyamide 612), polydecamethylene adipamide (polyamide 106), polydecamethylene sebacamide (polyamide 1010), polydecamethylene dodecamide (polyamide 1012), polyundecanamide (polyamide 11), polyundecamethylene adipamide (polyamide 116), polydodecanamide (polyamide 12), polyxylene adipamide (polyamide XD6), polyxylene sebacamide (polyamide XD10), polymetaxylylene adipamide (polyamide MXD6), polyparaxylylene adipamide (polyamide PXD6), polytetramethylene terephthalamide (polyamide 4T), polypentamethylene terephthalamide (polyamide 5T), polyhexamethylene terephthalamide (polyamide 6T), polyhexamethylene isophthalamide (polyamide 6I), polynonamethylene terephthalamide (polyamide 9T), polydecamethylene terephthalamide (polyamide 10T), polyundecamethylene terephthalamide (polyamide 11T), polydodecamethylene terephthalamide (polyamide 12T), polytetramethylene isophthalamide (polyamide 41), polybis(3-methyl-4-aminohexyl) methane terephthalamide (polyamide PACMT), polybis(3-methyl-4-aminohexyl) methane isophthalamide (polyamide PACMI), polybis(3-methyl-4-aminohexyl) methane dodecamide (polyamide PACM12), and polybis(3-methyl-4-aminohexyl) methane tetradecamide (polyamide PACM14), or copolymers obtained by combining two or more of the components, and mixtures thereof.

Examples of the polycarbonate can include polymers obtained by a transesterification method in which a dihydroxydiaryl compound is reacted with a carbonate such as diphenyl carbonate in a molten state; or polymers obtained by phosgene method in which a dihydroxyaryl compound is reacted with phosgene.

Examples of the polybutylene terephthalate can include polymers obtained by polycondensation of terephthalic acid or a derivative thereof with 1,4-butanediol. Examples of the polyaryl ether ketone can include polyetherketone (PEK), polyetheretherketone (PEEK), polyetherketoneketone (PEKK), and polyetheretherketoneketone (PEEKK).

Examples of the polyethylene can include high density polyethylene (HDPE), medium density polyethylene, low density polyethylene (LDPE), linear low density polyethylene (LLDPE), and ultra-high molecular weight polyethylene.

Examples of the polypropylene can include isotactic polypropylene, atactic polypropylene, syndiotactic polypropylene, and mixtures thereof.

Examples of the polystyrene can include general-purpose polystyrene (GPPS), which is an atactic polystyrene having an atactic structure, high impact polystyrene (HIPS) with a rubber component added to GPPS, and syndiotactic polystyrene having a syndiotactic structure.

Examples of the methacrylic resin can include polymers obtained by homopolymerizing one of acrylic acid, methacrylic acid, styrene, methyl acrylate, ethyl acrylate, ethyl methacrylate, butyl acrylate, butyl methacrylate, and fatty acid vinyl ester, or polymers obtained by copolymerizing two or more of these.

Examples of the polyvinyl chloride can include a vinyl chloride homopolymer, a copolymer of a vinyl chloride monomer and a copolymerizable monomer, or a graft copolymer obtained by graft polymerization of a vinyl chloride monomer to polymer polymerized by a conventionally known method such as emulsion polymerization method, suspension polymerization method, micro suspension polymerization method, or bulk polymerization method.

Examples of the polyacetal can include a homopolymer with oxymethylene units as the main repeating unit, and a copolymer mainly composed of oxymethylene units and containing oxyalkylene units having 2 to 8 adjacent carbon atoms in the main chain.

Examples of the polyethylene terephthalate can include polymers obtained by polycondensation of terephthalic acid or a derivative thereof with ethylene glycol.

Examples of the polytrimethylene terephthalate can include polymers obtained by polycondensation of terephthalic acid or a derivative thereof with 1,3-propanediol.

Examples of the polyarylene sulfide can include linear polyphenylene sulfide, crosslinked polyphenylene sulfide having a high molecular weight obtained by performing a curing reaction after polymerization, polyphenylene sulfide sulfone, polyphenylene sulfide ether, and polyphenylene sulfide ketone.

Examples of the modified polyphenylene ether include a polymer alloy of poly(2,6-dimethyl-1,4-phenylene)ether and polystyrene; a polymer alloy of poly(2,6-dimethyl-1,4-phenylene)ether and a styrene/butadiene copolymer; a polymer alloy of poly(2,6-dimethyl-1,4-phenylene)ether and a styrene/maleic anhydride copolymer; a polymer alloy of poly(2,6-dimethyl-1,4-phenylene)ether and polyamide; and a polymer alloy of poly(2,6-dimethyl-1,4-phenylene)ether and a styrene/butadiene/acrylonitrile copolymer.

Examples of the liquid crystal polymer (LCP) can include a polymer (copolymer) composed of one or more structural units selected from aromatic hydroxycarbonyl units which are thermotropic liquid crystal polyesters, aromatic dihydroxy units, aromatic dicarbonyl units, aliphatic dihydroxy units, and aliphatic dicarbonyl units.

Examples of the fluororesin can include polytetrafluoroethylene (PTFE), perfluoroalkoxy resins (PFA), fluorinated ethylene propylene resins (FEP), fluorinated ethylene tetrafluoroethylene resins (ETFE), polyvinyl fluoride (PVF), polyvinylidene fluoride (PVDF), polychlorotrifluoroethylene (PCTFE), and ethylene/chlorotrifluoroethylene resin (ECTFE).

Examples of the ionomer (IO) resin can include copolymers of an olefin or a styrene and an unsaturated carboxylic acid, wherein a part of carboxyl groups is neutralized with a metal ion.

Examples of the olefin/vinyl alcohol resin can include ethylene/vinyl alcohol copolymers, propylene/vinyl alcohol copolymers, saponified products of ethylene/vinyl acetate copolymers, and saponified products of propylene/vinyl acetate copolymers.

Examples of the cyclic olefin resin can include monocyclic compounds such as cyclohexene, polycyclic compounds such as tetracyclopentadiene, and polymers of cyclic olefin monomers.

Examples of the polylactic acid can include poly-L-lactic acid, which is a homopolymer of L-form, poly-D-lactic acid, which is a homopolymer of D-form, or a stereocomplex polylactic acid which is a mixture thereof.

Examples of the cellulose resin can include methylcellulose, ethylcellulose, hydroxycellulose, hydroxymethylcellulose, hydroxyethylcellulose, hydroxyethyl methylcellulose, hydroxypropyl methylcellulose, cellulose acetate, cellulose propionate, and cellulose butyrate.

In the glass-reinforced resin molded article of the present embodiment, the content of the glass-reinforcing material is preferably in the range of 20.0 to 75.0% by mass, more preferably in the range of 30.0 to 69.5% by mass, further preferably in the range of 40.0 to 67.0% by mass, particularly preferably in the range of 45.0 to 63.0% by mass, and most preferably in the range of 50.0 to 60.0% by mass, with respect to the total amount of the glass-reinforced resin molded article.

In the glass-reinforced resin molded article of the present embodiment, the content of the glass-reinforcing material with respect to the total amount of the glass-reinforced resin molded article can be calculated as follows. First, the mass of the glass-reinforced resin molded article (mass before heating) is measured. Next, the glass-reinforced resin molded article is heated in a muffle furnace under a condition of 625° C. for a time period in the range of 0.5 to 24 hours to burn the resin component off. Next, the mass of the glass material left after the resin component is burned off (mass after heating) is measured. The content of the glass-reinforcing material can be calculated, from the mass before heating and mass after heating obtained, by (mass after heating/mass before heating)×100. When materials other than the glass material are included after the resin component is burned off, the glass material can be separated by use of the difference in the specific gravities of these materials.

In the glass-reinforced resin molded article of the present embodiment, the content of the thermoplastic resin is preferably in the range of 80.0 to 25.0% by mass, more preferably in the range of 70.0 to 30.5% by mass, further preferably in the range of 60.0 to 33.0% by mass, particularly preferably in the range of 55.0 to 37.0% by mass, and most preferably in the range of 50.0 to 40.0% by mass, with respect to the total amount of the glass-reinforced resin molded article.

In the glass-reinforced resin molded article of the present embodiment, the content of the thermoplastic resin with respect to the total amount of the glass-reinforced resin molded article can be calculated as follows. First, the mass of the glass-reinforced resin molded article (mass before heating) is measured. Next, the glass-reinforced resin molded article is heated in a muffle furnace under a condition of 625° C. for a time period in the range of 0.5 to 24 hours to burn the resin component off. Next, the mass of the substance left after the resin component is burned off (mass after heating) is measured. The content of the thermoplastic resin can be calculated, from the mass before heating and mass after heating obtained, by ((mass before heating−mass after heating)/mass before heating)×100.

In the glass-reinforced resin molded article of the present embodiment, the content C of the flat cross-section glass fiber is preferably in the range of 20.0 to 70.0% by mass, more preferably in the range of 30.0 to 67.0% by mass, further preferably in the range of 40.0 to 65.0% by mass, particularly preferably in the range of 45.0 to 62.0% by mass, and most preferably in the range of 50.0 to 60.0% by mass, with respect to the total amount of the glass-reinforced resin molded article.

In the glass-reinforced resin molded article of the present embodiment, the content C of the flat cross-section glass fiber with respect to the total amount of the glass-reinforced resin molded article can be calculated as follows. First, a cross section of the glass-reinforced resin molded article is polished, the cross-sectional shape (the shape of a cross section obtained by cutting at a face that orthogonally intersects the length direction) of at least 200 glass material is observed using a scanning electron microscope (SEM). Here, in all the glass material of which the cross-sectional shape has been observed, when the cross-sectional shape is flat, the content of the glass-reinforcing material with respect to the total amount of the glass-reinforced resin molded article calculated by the method described above is used as the content C of the flat cross-section glass fiber. In contrast, when the glass material of which the cross section has been observed includes ones having a circular cross-sectional shape and ones having a flat cross-sectional shape, the cross-sectional area and the length of the glass material are measured for at least 200 glass material left after the resin component is burned off using a SEM and a stereoscopic microscope, and the volume ratio between the glass material having a flat cross-sectional shape and the glass material having a circular cross-sectional shape is calculated. Then, prorating the content of the glass-reinforcing material based on the volume ratio calculated enables the content C of the flat cross-section glass fiber to be calculated. When materials other than the glass material are included in analyzing the cross-sectional shape using a SEM, the glass material can be separated by composition analysis (SEM-EDX analysis).

The ratio of the total content of the glass-reinforcing materials other than the flat cross-section glass fiber to the content C of the flat cross-section glass fiber is, for example, in the range of 0 to 0.50, preferably in the range of 0 to 0.30, further preferably in the range of 0 to 0.10, particularly preferably in the range of 0 to 0.05, and most preferably 0.

The major axis D of the flat cross-section glass fiber used in the glass-reinforced resin molded article of the present embodiment is preferably in the range of 30.0 to 50.0 μm, more preferably in the range of 30.5 to 45.0 μm, and further preferably in the range of 31.0 to 43.0 μm. In the flat cross-section glass fiber used in the glass-reinforced resin molded article of the present embodiment, the major axis D is particularly preferably in the range of 31.0 to 35.0 μm from the viewpoint of improving the fluidity of a kneaded product of the glass-reinforcing material and the thermoplastic resin in producing the glass-reinforced resin molded article, and particularly preferably in the range of 37.0 to 43.0 μm from the viewpoint of improving the strength of the glass-reinforced resin molded article.

The minor axis of the flat cross-section glass fiber used in the glass-reinforced resin molded article of the present embodiment is, for example, in the range of 3.0 to 18.0 μm, preferably in the range of 3.5 to 9.5 μm, more preferably in the range of 3.7 to 8.0 μm, further preferably in the range of 4.0 to 7.4 μm, particularly preferably in the range of 4.5 to 7.0 μm, and most preferably in the range of 5.0 to 6.4 μm.

The major axis D and the minor axis of the flat cross-section glass fiber used in the glass-reinforced resin molded article of the present embodiment can be calculated as follows, for example. First, a cross section of the glass-reinforced resin molded article is polished. Then, the length of the major axis D and the minor axis of 100 or more glass filaments having a flat cross-sectional shape are measured using an electron microscope by taking the major axis D as the longest side that passes through the substantial center of the glass filament cross section and the minor axis as the side that orthogonally intersects the major axis D at the substantial center of the glass filament cross section. The average values of these values are determined, thereby enabling the minor axis and major axis to be calculated.

The ratio of the major axis to the minor axis (major axis/minor axis) of the flat cross-section glass fiber used in the glass-reinforced resin molded article of the present embodiment is preferably in the range of 5.0 to 8.0, more preferably in the range of 5.5 to 7.5, further preferably in the range of 5.6 to 7.0, and particularly preferably in the range of 5.7 to 6.6.

In the glass-reinforced resin molded article of the present embodiment, the proportion P of the glass-reinforcing material having a length in the range of 50 to 100 μm with respect to the total number of the glass-reinforcing material having a length of 50 μm or more included in glass-reinforced resin molded article is preferably in the range of 10 to 40%, more preferably in the range of 15 to 38%, further preferably in the range of 20 to 37%, particularly preferably in the range of 26 to 36%, and most preferably in the range of 27 to 35%. The P can be determined by the method described in Examples below.

In the glass-reinforced resin molded article of the present embodiment, the proportion of the glass-reinforcing material having a length in the range of 300 to 500 μm with respect to the total number of the glass-reinforcing material having a length of 50 μm or more included in the glass-reinforced resin molded article is preferably less than 7.0%, more preferably less than 5.0%, and further preferably less than 3.0%.

In the glass-reinforced resin molded article of the present embodiment, the proportion of the glass-reinforcing material having a length in the range of 25 to 100 μm with respect to the total number of the glass-reinforcing material having a length of 25 μm or more included in the glass-reinforced resin molded article is, for example, in the range of 30 to 60%, preferably in the range of 35 to 55%, and more preferably in the range of 40 to 50%.

In the glass-reinforced resin molded article of the present embodiment, when the C is in the range of 20.0 to 70.0% by mass, the D is in the range of 30.0 to 50.0 μm, and the P is in the range of 10 to 40%, the C, D, and P preferably satisfy the following formula (2):

$$0.54 \leq P / {( C \times D )}^{1 / 2} \leq 0.72 . \qquad ( 2 )$$

In the glass-reinforced resin molded article of the present embodiment, when the ratio of the major axis to the minor axis (major axis/minor axis) of the flat cross-section glass fiber is in the range of 5.0 to 8.0, the C is in the range of 20.0 to 70.0% by mass, the D is in the range of 31.0 to 43.0 μm, and the P is in the range of 10 to 40%, the C, D, and P further preferably satisfy the following formula (3):

$$0.59 \leq P / {( C \times D )}^{1 / 2} \leq 0.71 . \qquad ( 3 )$$

In the glass-reinforced resin molded article of the present embodiment, when the ratio of the major axis to the minor axis (major axis/minor axis) of the flat cross-section glass fiber is in the range of 5.7 to 6.6, the C is in the range of 20.0 to 70.0% by mass, the D is in the range of 31.0 to 35.0 μm, and the P is in the range of 10 to 40%, the C, D, and P particularly preferably satisfy the following formula (4):

$$0.60 \leq P / {( C \times D )}^{1 / 2} \leq 0.7 . \qquad ( 4 )$$

The glass-reinforced resin molded article of the present embodiment is preferably used for a housing or a part of a portable electronic device such as a smartphone, a tablet, a laptop computer, and a mobile computer (such as a mother board, a frame, a speaker, and an antenna).

Then, Examples and Comparative Examples of the present invention will be shown.

### EXAMPLES

### Example 1

In the present example, first, as a glass-reinforcing material, 30.0% by mass of flat cross-section glass fiber with respect to the total amount and, as a thermoplastic resin, 70.0% by mass of polycarbonate (manufactured by TEIJIN LIMITED, trade name: Panlite L1250Y (denoted as PC in Tables 1 to 2)) with respect to the total amount were kneaded with a screw rotation speed of 110 rpm in a twin-screw kneader (manufactured by SHIBAURA MACHINE CO., LTD., trade name: TEM-26SS) to obtain resin pellets. The flat cross-section glass fiber has an E glass composition and has a minor axis of 5.5 μm, a major axis D of 33.0 μm, and major axis/minor axis of 6.0.

Then, the resin pellets obtained in the present example were used to conduct injection molding in an injection molding apparatus (manufactured by Nissei Plastic Industrial Co. Ltd., trade name: NEX80) at a mold temperature of 120° C. and an injection temperature of 300° ° C. to thereby produce a glass-reinforced resin molded article (glass-reinforced resin injection-molded article) having a size of 80 mm in length×60 mm in width and a thickness of 2.0 mm.

Then, the glass-reinforced resin molded article produced in the present example was measured for the TD direction shrinkage ratio and the MD direction shrinkage ratio to thereby determine MD direction shrinkage ratio/TD direction shrinkage ratio. TD direction shrinkage ratio/reference shrinkage ratio was also determined by using the TD direction shrinkage ratio of the glass-reinforced resin molded article of Reference Example 1 described below as the reference shrinkage ratio.

Next, for the glass-reinforced resin molded article produced in the present example, the proportion P of the glass-reinforcing material having a length in the range of 50 to 100 μm with respect to the total number of the glass-reinforcing material having a length of 50 μm or more included in the glass-reinforced resin molded article, and the proportion of the glass-reinforcing material having a length in the range of 25 to 100 μm with respect to the total number of the glass-reinforcing material having a length of 25 μm or more included in the glass-reinforced resin molded article were determined by the methods described below.

Next, from the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 1.

[Proportion P of glass-reinforcing material having length in range of 50 to 100 μm with respect to total number of glass-reinforcing material having length of 50 μm or more included in glass-reinforced resin molded article]

First, the glass-reinforced resin molded article was heated in a muffle furnace at 650° ° C. for a time period in the range of 0.5 to 24 hours to decompose organic matter. Then, the remaining glass material was transferred to a glass petri dish, and the glass material was dispersed using acetone on the surface of the petri dish. Subsequently, the fiber length of 1000 or more glass material dispersed on the petri dish surface was measured using a stereoscopic microscope, and the total number of glass material having a length of 50 μm or more and the number of glass material having a length of 50 to 100 μm were counted (target counting). Then, ((number of glass material having a length of 50 to 100 μm)/(total number of glass material having a length of 50 μm or more))×100 was calculated to determine the proportion P of the glass-reinforcing material having a length in the range of 50 to 100 μm with respect to the total number of the glass-reinforcing material having a length of 50 μm or more.

[Proportion of glass-reinforcing material having a length in range of 25 to 100 μm with respect to total number of glass-reinforcing material having length of 25 μm or more included in glass-reinforced resin molded article]

First, the glass-reinforced resin molded article was heated in a muffle furnace at 650° ° C. for a time period in the range of 0.5 to 24 hours to decompose organic matter. Then, the remaining glass material was transferred to a glass petri dish, and the glass material was dispersed using acetone on the surface of the petri dish. Subsequently, the fiber length of 1000 or more glass material dispersed on the petri dish surface was measured using a stereoscopic microscope, and the total number of glass material having a length of 25 μm or more and the number of glass material having a length of 25 to 100 μm were counted (target counting). Then, ((number of glass material having a length of 25 to 100 μm)/(total number of glass material having a length of 25 μm or more))×100 was calculated to determine the proportion of the glass-reinforcing material having a length in the range of 25 to 100 μm with respect to the total number of the glass-reinforcing material having a length of 25 μm or more.

### Example 2

In the present example, resin pellets were obtained in the entirely same manner as in Example 1, except that flat cross-section glass fiber having a minor axis of 7.0 μm, a major axis D of 42.0 μm, and major axis/minor axis of 6.0 was used for kneading in a twin-screw kneader with a screw rotation speed of 100 rpm.

Then, a glass-reinforced resin molded article was produced in the entirely same manner as in Example 1, except that the resin pellets obtained in the present example were used.

Next, for the glass-reinforced resin molded article produced in the present example, in the entirely same manner as in Example 1, MD direction shrinkage ratio/TD direction shrinkage ratio, TD direction shrinkage ratio/reference shrinkage ratio, the proportion P of the glass-reinforcing material having a length in the range of 50 to 100 μm with respect to the total number of the glass-reinforcing material having a length of 50 μm or more included in the glass-reinforced resin molded article, and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 1.

### Example 3

In the present example, resin pellets were obtained in the entirely same manner as in Example 1, except that flat cross-section glass fiber having a minor axis of 11.0 μm, a major axis D of 44.0 μm, and major axis/minor axis of 4.0 was used for kneading in a twin-screw kneader with a screw rotation speed of 200 rpm.

Then, a glass-reinforced resin molded article was produced in the entirely same manner as in Example 1, except that the resin pellets obtained in the present example were used.

Next, for the glass-reinforced resin molded article produced in the present example, in the entirely same manner as in Example 1, MD direction shrinkage ratio/TD direction shrinkage ratio, TD direction shrinkage ratio/reference shrinkage ratio, the proportion P of the glass-reinforcing material having a length in the range of 50 to 100 μm with respect to the total number of the glass-reinforcing material having a length of 50 μm or more included in the glass-reinforced resin molded article, and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 1.

### Example 4

In the present example, first, as glass-reinforcing materials, 28.0% by mass of flat cross-section glass fiber with respect to the total amount and 2.0% by mass of glass flake with respect to the total amount, and as a thermoplastic resin, 70.0% by mass of polycarbonate with respect to the total amount were kneaded in a twin-screw kneader with a screw rotation speed of 110 rpm to obtain resin pellets. The flat cross-section glass fiber has an E glass composition and has a minor axis of 5.5 μm, a major axis D of 33.0 μm, and major axis/minor axis of 6.0. The glass flake has a thickness of 5 μm and a particle size of 160 μm.

Then, a glass-reinforced resin molded article was produced in the entirely same manner as in Example 1, except that the resin pellets obtained in the present example were used.

Next, for the glass-reinforced resin molded article produced in the present example, in the entirely same manner as in Example 1, MD direction shrinkage ratio/TD direction shrinkage ratio, TD direction shrinkage ratio/reference shrinkage ratio, the proportion P of the glass-reinforcing material having a length in the range of 50 to 100 μm with respect to the total number of the glass-reinforcing material having a length of 50 μm or more included in the glass-reinforced resin molded article, and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 1.

### Example 5

In the present example, resin pellets were obtained in the entirely same manner as in Example 4, except that, as glass-reinforcing materials, 24.0% by mass of flat cross-section glass fiber with respect to the total amount and 6.0% by mass of glass flake with respect to the total amount were used.

Then, a glass-reinforced resin molded article was produced in the entirely same manner as in Example 1, except that the resin pellets obtained in the present example were used.

Next, for the glass-reinforced resin molded article produced in the present example, in the entirely same manner as in Example 1, MD direction shrinkage ratio/TD direction shrinkage ratio, TD direction shrinkage ratio/reference shrinkage ratio, the proportion P of the glass-reinforcing material having a length in the range of 50 to 100 μm with respect to the total number of the glass-reinforcing material having a length of 50 μm or more included in the glass-reinforced resin molded article, and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 1.

### Comparative Example 1

In the present comparative example, resin pellets were obtained in the entirely same manner as in Example 1, except that flat cross-section glass fiber having a minor axis of 7.0 μm, a major axis D of 28.0 μm, and major axis/minor axis of 4.0 was used for kneading in a twin-screw kneader with a screw rotation speed of 100 rpm.

Then, a glass-reinforced resin molded article was produced in the entirely same manner as in Example 1, except that the resin pellets obtained in the present comparative example were used.

Next, for the glass-reinforced resin molded article produced in the present comparative example, in the entirely same manner as in Example 1, MD direction shrinkage ratio/TD direction shrinkage ratio, TD direction shrinkage ratio/reference shrinkage ratio, the proportion P of the glass-reinforcing material having a length in the range of 50 to 100 μm with respect to the total number of the glass-reinforcing material having a length of 50 μm or more included in the glass-reinforced resin molded article, and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 2.

### Comparative Example 2

In the present comparative example, resin pellets were obtained in the entirely same manner as in Example 1, except that flat cross-section glass fiber having a minor axis of 11.0 μm, a major axis D of 44.0 μm, and major axis/minor axis of 4.0 was used for kneading in a twin-screw kneader with a screw rotation speed of 100 rpm.

Then, a glass-reinforced resin molded article was produced in the entirely same manner as in Example 1, except that the resin pellets obtained in the present comparative example were used.

Next, for the glass-reinforced resin molded article produced in the present comparative example, in the entirely same manner as in Example 1, MD direction shrinkage ratio/TD direction shrinkage ratio, TD direction shrinkage ratio/reference shrinkage ratio, the proportion P of the glass-reinforcing material having a length in the range of 50 to 100 μm with respect to the total number of the glass-reinforcing material having a length of 50 μm or more included in the glass-reinforced resin molded article, and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 2.

### Comparative Example 3

In the present comparative example, first, as glass-reinforcing materials, 10.0% by mass of flat cross-section glass fiber with respect to the total amount and 20.0% by mass of glass flake with respect to the total amount, and as a thermoplastic resin, 70.0% by mass of polycarbonate with respect to the total amount were kneaded in a twin-screw kneader with a screw rotation speed of 110 rpm to obtain resin pellets. The flat cross-section glass fiber has an E glass composition and has a minor axis of 5.5 μm, a major axis D of 33.0 μm, and major axis/minor axis of 6.0. The glass flake has a thickness of 5 μm and a particle size of 160 μm.

Then, a glass-reinforced resin molded article was produced in the entirely same manner as in Example 1, except that the resin pellets obtained in the present comparative example were used.

Next, for the glass-reinforced resin molded article produced in the present comparative example, in the entirely same manner as in Example 1, MD direction shrinkage ratio/TD direction shrinkage ratio, TD direction shrinkage ratio/reference shrinkage ratio, the proportion P of the glass-reinforcing material having a length in the range of 50 to 100 μm with respect to the total number of the glass-reinforcing material having a length of 50 μm or more included in the glass-reinforced resin molded article, and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 2.

### Comparative Example 4

In the present comparative example, resin pellets were obtained in the entirely same manner as in Comparative Example 3, except that flat cross-section glass fiber having a minor axis of 7.0 μm, a major axis D of 28.0 μm, and major axis/minor axis of 4.0 was used for kneading in a twin-screw kneader with a screw rotation speed of 100 rpm.

Then, a glass-reinforced resin molded article was produced in the entirely same manner as in Example 1, except that the resin pellets obtained in the present comparative example were used.

Next, for the glass-reinforced resin molded article produced in the present comparative example, in the entirely same manner as in Example 1, MD direction shrinkage ratio/TD direction shrinkage ratio, TD direction shrinkage ratio/reference shrinkage ratio, the proportion P of the glass-reinforcing material having a length in the range of 50 to 100 μm with respect to the total number of the glass-reinforcing material having a length of 50 μm or more included in the glass-reinforced resin molded article, and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 2.

### Reference Example 1

In the present reference example, resin pellets were obtained in the entirely same manner as in Example 1, except that, as a glass-reinforcing material, circular cross-section glass fiber having a diameter of 11.0 μm was used for kneading in a twin-screw kneader with a screw rotation speed of 100 rpm.

Then, a glass-reinforced resin molded article was produced in the entirely same manner as in Example 1, except that the resin pellets obtained in the present reference example were used.

Then, for the glass-reinforced resin molded article produced in the present reference example, the MD direction shrinkage ratio, the TD direction shrinkage ratio, and MD direction shrinkage ratio/TD direction shrinkage ratio were determined in the entirely same manner as in Example 1, and the TD direction shrinkage ratio was used as the reference shrinkage ratio for Examples 1 to 5 and Comparative Examples 1 to 4. The results are shown in Table 1 and Table 2.

### Example 6

In the present example, first, as a glass-reinforcing material, 40.0% by mass of flat cross-section glass fiber with respect to the total amount, and as a thermoplastic resin, 60.0% by mass of polycarbonate (manufactured by TEIJIN LIMITED., trade name: Panlite L1250Y (denoted as PC in Table 3)) with respect to the total amount were kneaded with a screw rotation speed of 110 rpm in a twin-screw kneader (manufactured by SHIBAURA MACHINE CO., LTD., trade name: TEM-26SS) to obtain resin pellets. The flat cross-section glass fiber has an E glass composition and has a minor axis of 5.5 μm, a major axis D of 33.0 μm, and major axis/minor axis of 6.0.

Then, the resin pellets obtained in the present example were used to conduct injection molding in an injection molding apparatus (manufactured by Nissei Plastic Industrial Co. Ltd., trade name: NEX80) at a mold temperature of 120° ° C. and an injection temperature of 300° ° C. to thereby produce a glass-reinforced resin molded article having a size of 80 mm in length×60 mm in width and a thickness of 2.0 mm.

Then, the glass-reinforced resin molded article produced in the present example was measured for the TD direction shrinkage ratio and the MD direction shrinkage ratio to thereby determine MD direction shrinkage ratio/TD direction shrinkage ratio. TD direction shrinkage ratio/reference shrinkage ratio was also determined by using the TD direction shrinkage ratio of the glass-reinforced resin molded article of Reference Example 2 described below as the reference shrinkage ratio.

Next, for the glass-reinforced resin molded article produced in the present example, in the entirely same manner as in Example 1, the proportion P of the glass-reinforcing material having a length in the range of 50 to 100 μm with respect to the total number of the glass-reinforcing material having a length of 50 μm or more included in the glass-reinforced resin molded article and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 3.

### Example 7

In the present example, resin pellets were obtained in the entirely same manner as in Example 6, except that flat cross-section glass fiber having a minor axis of 7.0 μm, a major axis D of 42.0 μm, and major axis/minor axis of 6.0 was used for kneading in a twin-screw kneader with a screw rotation speed 100 rpm.

Then, a glass-reinforced resin molded article was produced in the entirely same manner as in Example 6, except that the resin pellets obtained in the present example were used.

Next, for the glass-reinforced resin molded article produced in the present example, in the entirely same manner as in Example 6, MD direction shrinkage ratio/TD direction shrinkage ratio, TD direction shrinkage ratio/reference shrinkage ratio, the proportion P of the glass-reinforcing material having a length in the range of 50 to 100 μm with respect to the total number of the glass-reinforcing material having a length of 50 μm or more included in the glass-reinforced resin molded article, and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 3.

### Reference Example 2

In the present reference example, resin pellets were obtained in the entirely same manner as in Example 6, except that, as a glass-reinforcing material, circular cross-section glass fiber having a diameter of 11.0 μm was used for kneading in a twin-screw kneader with a screw rotation speed of 100 rpm.

Then, a glass-reinforced resin molded article was produced in the entirely same manner as in Example 6, except that the resin pellets obtained in the present reference example were used.

Then, for the glass-reinforced resin molded article produced in the present reference example, the MID direction shrinkage ratio, the TD direction shrinkage ratio, and MID direction shrinkage ratio/TD direction shrinkage ratio were determined in the entirely same manner as in Example 6, and the TD direction shrinkage ratio was used as the reference shrinkage ratio for Examples 6 to 7. The results are shown in Table 3.

### Comparative Example 5

In the present comparative example, first, as a glass-reinforcing material, 20.0% by mass of flat cross-section glass fiber with respect to the total amount, and as a thermoplastic resin, 80.0% by mass of polycarbonate (manufactured by TEIJIN LIMITED, trade name: Panlite L1250Y (denoted as PC in Table 3)) with respect to the total amount were kneaded with a screw rotation speed of 100 rpm in a twin-screw kneader (manufactured by SHIBAURA MACHINE CO., LTD., trade name: TEM-26SS) to obtain resin pellets. The flat cross-section glass fiber has an E glass composition and has a minor axis of 7.0 μm, a major axis D of 28.0 μm, and major axis/minor axis of 4.0.

Then, the resin pellets obtained in the present comparative example were used to conduct injection molding in an injection molding apparatus (manufactured by Nissei Plastic Industrial Co. Ltd., trade name: NEX80) at a mold temperature of 120° C. and an injection temperature of 300° ° C. to thereby produce a glass-reinforced resin molded article having a size of 80 mm in length×60 mm in width and a thickness of 2.0 mm.

Then, the glass-reinforced resin molded article produced in the present comparative example was measured for the TD direction shrinkage ratio and the MD direction shrinkage ratio to thereby determine MD direction shrinkage ratio/TD direction shrinkage ratio. TD direction shrinkage ratio/reference shrinkage ratio was also determined by using the TD direction shrinkage ratio of the glass-reinforced resin molded article of Reference Example 3 described below as the reference shrinkage ratio.

Next, for the glass-reinforced resin molded article produced in the present comparative example, in the entirely same manner as in Example 1, the proportion P of the glass-reinforcing material having a length in the range of 50 to 100 μm with respect to the total number of the glass-reinforcing material having a length of 50 μm or more included in the glass-reinforced resin molded article and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 3.

### Comparative Example 6

In the present comparative example, resin pellets were obtained in the entirely same manner as in Comparative Example 5, except that flat cross-section glass fiber having a minor axis of 5.5 μm, a major axis D of 33.0 μm, and major axis/minor axis of 6.0 was used for kneading in a twin-screw kneader with a screw rotation speed of 110 rpm. Then, a glass-reinforced resin molded article was produced in the entirely same manner as in Comparative Example 5, except that the resin pellets obtained in the present comparative example were used.

Next, for the glass-reinforced resin molded article produced in the present comparative example, in the entirely same manner as in Comparative Example 5, MD direction shrinkage ratio/TD direction shrinkage ratio, TD direction shrinkage ratio/reference shrinkage ratio, the proportion P of the glass-reinforcing material having a length in the range of 50 to 100 μm with respect to the total number of the glass-reinforcing material having a length of 50 μm or more included in the glass-reinforced resin molded article, and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 3.

### Reference Example 3

In the present reference example, resin pellets were obtained in the entirely same manner as in Comparative Example 5, except that, as a glass-reinforcing material, circular cross-section glass fiber having a diameter of 11.0 μm was used for kneading in a twin-screw kneader with a screw rotation speed of 100 rpm.

Then, a glass-reinforced resin molded article was produced in the entirely same manner as in Comparative Example 5, except that the resin pellets obtained in the present reference example were used.

Then, for the glass-reinforced resin molded article produced in the present reference example, the MD direction shrinkage ratio, the TD direction shrinkage ratio, and MD direction shrinkage ratio/TD direction shrinkage ratio were determined in the entirely same manner as in Comparative Example 5, and the TD direction shrinkage ratio was used as the reference shrinkage ratio for Comparative Examples 5 to 6. The results are shown in Table 3.

### Example 8

In the present example, first, as a glass-reinforcing material, 30.0% by mass of flat cross-section glass fiber with respect to the total amount, and as a thermoplastic resin, 70.0% by mass of polybutylene terephthalate (manufactured by Polyplastics Co., Ltd., product name: DURANEX 2000 (denoted as PBT in Table 4)) with respect to the total amount were kneaded with a screw rotation speed of 110 rpm in a twin-screw kneader (manufactured by SHIBAURA MACHINE CO., LTD., trade name: TEM-26SS) to obtain resin pellets. The flat cross-section glass fiber has an E glass composition and has a minor axis of 5.5 μm, a major axis D of 33.0 μm, and major axis/minor axis of 6.0.

Then, the resin pellets obtained in the present example were used to conduct injection molding in an injection molding apparatus (manufactured by Nissei Plastic Industrial Co. Ltd., trade name: NEX80) at a mold temperature of 90° ° C. and an injection temperature of 250° ° C. to thereby produce a glass-reinforced resin molded article having a size of 80 mm in length×60 mm in width and a thickness of 2.0 mm.

Then, the glass-reinforced resin molded article produced in the present example was measured for the TD direction shrinkage ratio and the MD direction shrinkage ratio to thereby determine MD direction shrinkage ratio/TD direction shrinkage ratio. TD direction shrinkage ratio/reference shrinkage ratio was also determined by using the TD direction shrinkage ratio of the glass-reinforced resin molded article of Reference Example 4 described below as the reference shrinkage ratio.

Next, for the glass-reinforced resin molded article produced in the present example, in the entirely same manner as in Example 1, the proportion P of the glass-reinforcing material having a length in the range of 50 to 100 μm with respect to the total number of the glass-reinforcing material having a length of 50 μm or more included in the glass-reinforced resin molded article and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 4.

### Example 9

In the present example, resin pellets were obtained in the entirely same manner as in Example 8, except that flat cross-section glass fiber having a minor axis of 7.0 μm, a major axis D of 42.0 μm, and major axis/minor axis of 6.0 was used for kneading in a twin-screw kneader with a screw rotation speed 100 rpm.

Then, a glass-reinforced resin molded article was produced in the entirely same manner as in Example 8, except that the resin pellets obtained in the present example were used.

Next, for the glass-reinforced resin molded article produced in the present example, in the entirely same manner as in Example 8, MD direction shrinkage ratio/TD direction shrinkage ratio, TD direction shrinkage ratio/reference shrinkage ratio, the proportion P of the glass-reinforcing material having a length in the range of 50 to 100 μm with respect to the total number of the glass-reinforcing material having a length of 50 μm or more included in the glass-reinforced resin molded article, and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 4.

### Example 10

In the present example, resin pellets were obtained in the entirely same manner as in Example 8, except that flat cross-section glass fiber having a minor axis of 11.0 μm, a major axis D of 44.0 μm, and major axis/minor axis of 4.0 was used for kneading in a twin-screw kneader with a screw rotation speed of 200 rpm.

Then, a glass-reinforced resin molded article was produced in the entirely same manner as in Example 8, except that the resin pellets obtained in the present example were used.

Next, for the glass-reinforced resin molded article produced in the present example, in the entirely same manner as in Example 8, MD direction shrinkage ratio/TD direction shrinkage ratio, TD direction shrinkage ratio/reference shrinkage ratio, the proportion P of the glass-reinforcing material having a length in the range of 50 to 100 μm with respect to the total number of the glass-reinforcing material having a length of 50 μm or more included in the glass-reinforced resin molded article, and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 4.

### Comparative Example 7

In the present comparative example, resin pellets were obtained in the entirely same manner as in Example 8, except that flat cross-section glass fiber having a minor axis of 7.0 μm, a major axis D of 28.0 μm, and major axis/minor axis of 4.0 was used for kneading in a twin-screw kneader with a screw rotation speed of 100 rpm.

Then, a glass-reinforced resin molded article was produced in the entirely same manner as in Example 8, except that the resin pellets obtained in the present comparative example were used.

Next, for the glass-reinforced resin molded article produced in the present comparative example, in the entirely same manner as in Example 8, MD direction shrinkage ratio/TD direction shrinkage ratio, TD direction shrinkage ratio/reference shrinkage ratio, the proportion P of the glass-reinforcing material having a length in the range of 50 to 100 μm with respect to the total number of the glass-reinforcing material having a length of 50 μm or more included in the glass-reinforced resin molded article, and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 4.

### Comparative Example 8

In the present comparative example, resin pellets were obtained in the entirely same manner as in Example 8, except that flat cross-section glass fiber having a minor axis of 11.0 μm, a major axis D of 44.0 μm, and major axis/minor axis of 4.0 was used for kneading in a twin-screw kneader with a screw rotation speed of 100 rpm.

Then, a glass-reinforced resin molded article was produced in the entirely same manner as in Example 8, except that the resin pellets obtained in the present comparative example were used.

Next, for the glass-reinforced resin molded article produced in the present comparative example, in the entirely same manner as in Example 8, MD direction shrinkage ratio/TD direction shrinkage ratio, TD direction shrinkage ratio/reference shrinkage ratio, the proportion P of the glass-reinforcing material having a length in the range of 50 to 100 μm with respect to the total number of the glass-reinforcing material having a length of 50 μm or more included in the glass-reinforced resin molded article, and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 4.

### Reference Example 4

In the present reference example, resin pellets were obtained in the entirely same manner as in Example 8, except that, as a glass-reinforcing material, circular cross-section glass fiber having a diameter of 11.0 μm was used for kneading in a twin-screw kneader with a screw rotation speed of 100 rpm.

Then, a glass-reinforced resin molded article was produced in the entirely same manner as in Example 8, except that the resin pellets obtained in the present reference example were used.

Then, for the glass-reinforced resin molded article produced in the present reference example, the MD direction shrinkage ratio, the TD direction shrinkage ratio, and MD direction shrinkage ratio/TD direction shrinkage ratio were determined in the entirely same manner as in Example 8, and the TD direction shrinkage ratio was used as the reference shrinkage ratio for Examples 8 to 10 and Comparative Examples 7 to 8. The results are shown in Table 4.

### Example 11

In the present example, first, as a glass-reinforcing material, 40.0% by mass of flat cross-section glass fiber with respect to the total amount, and as a thermoplastic resin, 60.0% by mass of polybutylene terephthalate (manufactured by Polyplastics Co., Ltd., product name: DURANEX 2000 (denoted as PBT in Table 5)) with respect to the total amount were kneaded with a screw rotation speed of 110 rpm in a twin-screw kneader (manufactured by SHIBAURA MACHINE CO., LTD., trade name: TEM-26SS) to obtain resin pellets. The flat cross-section glass fiber has an E glass composition and has a minor axis of 5.5 μm, a major axis D of 33.0 μm, and major axis/minor axis of 6.0.

Then, the resin pellets obtained in the present example were used to conduct injection molding in an injection molding apparatus (manufactured by Nissei Plastic Industrial Co. Ltd., trade name: NEX80) at a mold temperature of 90° ° C. and an injection temperature of 250° C. to thereby produce a glass-reinforced resin molded article having a size of 80 mm in length×60 mm in width and a thickness of 2.0 mm.

Then, the glass-reinforced resin molded article produced in the present example was measured for the TD direction shrinkage ratio and the MD direction shrinkage ratio to thereby determine MD direction shrinkage ratio/TD direction shrinkage ratio. TD direction shrinkage ratio/reference shrinkage ratio was also determined by using the TD direction shrinkage ratio of the glass-reinforced resin molded article of Reference Example 5 described below as the reference shrinkage ratio.

Next, for the glass-reinforced resin molded article produced in the present example, in the entirely same manner as in Example 1, the proportion P of the glass-reinforcing material having a length in the range of 50 to 100 μm with respect to the total number of the glass-reinforcing material having a length of 50 μm or more included in the glass-reinforced resin molded article and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 5.

### Example 12

In the present example, resin pellets were obtained in the entirely same manner as in Example 11, except that flat cross-section glass fiber having a minor axis of 7.0 μm, a major axis D of 42.0 μm, and major axis/minor axis of 6.0 was used for kneading in a twin-screw kneader with a screw rotation speed 100 rpm.

Then, a glass-reinforced resin molded article was produced in the entirely same manner as in Example 11, except that the resin pellets obtained in the present example were used.

Next, for the glass-reinforced resin molded article produced in the present example, in the entirely same manner as in Example 11, MD direction shrinkage ratio/TD direction shrinkage ratio, TD direction shrinkage ratio/reference shrinkage ratio, the proportion P of the glass-reinforcing material having a length in the range of 50 to 100 μm with respect to the total number of the glass-reinforcing material having a length of 50 μm or more included in the glass-reinforced resin molded article, and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 5.

### Comparative Example 9

In the present comparative example, resin pellets were obtained in the entirely same manner as in Example 11, except that flat cross-section glass fiber having a minor axis of 7.0 μm, a major axis D of 28.0 μm, and major axis/minor axis of 4.0 was used for kneading in a twin-screw kneader with a screw rotation speed of 100 rpm.

Then, a glass-reinforced resin molded article was produced in the entirely same manner as in Example 11, except that the resin pellets obtained in the present comparative example were used.

Next, for the glass-reinforced resin molded article produced in the present comparative example, in the entirely same manner as in Example 11, MD direction shrinkage ratio/TD direction shrinkage ratio, TD direction shrinkage ratio/reference shrinkage ratio, the proportion P of the glass-reinforcing material having a length in the range of 50 to 100 μm with respect to the total number of the glass-reinforcing material having a length of 50 μm or more included in the glass-reinforced resin molded article, and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 5.

### Reference Example 5

In the present reference example, resin pellets were obtained in the entirely same manner as in Example 11, except that, as a glass-reinforcing material, circular cross-section glass fiber having a diameter of 11.0 μm was used for kneading in a twin-screw kneader with a screw rotation speed of 100 rpm.

Then, a glass-reinforced resin molded article was produced in the entirely same manner as in Example 11, except that the resin pellets obtained in the present reference example were used.

Then, for the glass-reinforced resin molded article produced in the present reference example, the MD direction shrinkage ratio, the TD direction shrinkage ratio, and MID direction shrinkage ratio/TD direction shrinkage ratio were determined in the entirely same manner as in Example 11, and the TD direction shrinkage ratio was used as the reference shrinkage ratio for Examples 11 to 12 and Comparative Example 9. The results are shown in Table 5.

### Example 13

In the present example, first, as a glass-reinforcing material, 60.0% by mass of flat cross-section glass fiber with respect to the total amount, and as a thermoplastic resin, 40.0% by mass of polyamide (manufactured by Ube Industries, Ltd., product name: UBE 1015B (denoted as PA in Table 6)) with respect to the total amount were kneaded with a screw rotation speed of 100 rpm in a twin-screw kneader (manufactured by SHIBAURA MACHINE CO., LTD., trade name: TEM-26SS) to obtain resin pellets. The flat cross-section glass fiber has an E glass composition and has a minor axis of 7.0 μm, a major axis D of 42.0 μm, and major axis/minor axis of 6.0.

Then, the resin pellets obtained in the present example were used to conduct injection molding in an injection molding apparatus (manufactured by Nissei Plastic Industrial Co. Ltd., trade name: NEX80) at a mold temperature of 90° ° C. and an injection temperature of 270° ° C. to thereby produce a glass-reinforced resin molded article having a size of 80 mm in length×60 mm in width and a thickness of 2.0 mm.

Then, the glass-reinforced resin molded article produced in the present example was measured for the TD direction shrinkage ratio and the MD direction shrinkage ratio to thereby determine MD direction shrinkage ratio/TD direction shrinkage ratio. TD direction shrinkage ratio/reference shrinkage ratio was also determined by using the TD direction shrinkage ratio of the glass-reinforced resin molded article of Reference Example 6 described below as the reference shrinkage ratio.

Next, for the glass-reinforced resin molded article produced in the present example, in the entirely same manner as in Example 1, the proportion P of the glass-reinforcing material having a length in the range of 50 to 100 μm with respect to the total number of the glass-reinforcing material having a length of 50 μm or more included in the glass-reinforced resin molded article and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 6.

### Example 14

In the present example, resin pellets were obtained in the entirely same manner as in Example 13, except that flat cross-section glass fiber having a minor axis of 5.5 μm, a major axis D of 33.0 μm, and major axis/minor axis of 6.0 was used for kneading in a twin-screw kneader with a screw rotation speed of 110 rpm.

Then, a glass-reinforced resin molded article was produced in the entirely same manner as in Example 13, except that the resin pellets obtained in the present example were used.

Next, for the glass-reinforced resin molded article produced in the present example, in the entirely same manner as in Example 13, MD direction shrinkage ratio/TD direction shrinkage ratio, TD direction shrinkage ratio/reference shrinkage ratio, the proportion P of the glass-reinforcing material having a length in the range of 50 to 100 μm with respect to the total number of the glass-reinforcing material having a length of 50 μm or more included in the glass-reinforced resin molded article, and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 6.

### Example 15

In the present example, resin pellets were obtained in the entirely same manner as in Example 13, except that flat cross-section glass fiber having a minor axis of 11.0 μm, a major axis D of 44.0 μm, and major axis/minor axis of 4.0 was used for kneading in a twin-screw kneader with a screw rotation speed of 130 rpm.

Then, a glass-reinforced resin molded article was produced in the entirely same manner as in Example 13, except that the resin pellets obtained in the present example were used.

Next, for the glass-reinforced resin molded article produced in the present example, in the entirely same manner as in Example 13, MD direction shrinkage ratio/TD direction shrinkage ratio, TD direction shrinkage ratio/reference shrinkage ratio, the proportion P of the glass-reinforcing material having a length in the range of 50 to 100 μm with respect to the total number of the glass-reinforcing material having a length of 50 μm or more included in the glass-reinforced resin molded article, and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 6.

### Reference Example 6

In the present reference example, resin pellets were obtained in the entirely same manner as in Example 13, except that, as a glass-reinforcing material, circular cross-section glass fiber having a diameter of 11.0 μm was used for kneading in a twin-screw kneader with a screw rotation speed of 100 rpm.

Then, a glass-reinforced resin molded article was produced in the entirely same manner as in Example 13, except that the resin pellets obtained in the present reference example were used.

Then, for the glass-reinforced resin molded article produced in the present reference example, the MID direction shrinkage ratio, the TD direction shrinkage ratio, and MID direction shrinkage ratio/TD direction shrinkage ratio were determined in the entirely same manner as in Example 13, and the TD direction shrinkage ratio was used as the reference shrinkage ratio for Examples 13 to 15. The results are shown in Table 6.

### Comparative Example 10

In the present comparative example, first, as a glass-reinforcing material, 30.0% by mass of flat cross-section glass fiber with respect to the total amount, and as a thermoplastic resin, 70.0% by mass of polyamide (manufactured by Ube Industries, Ltd., product name: UBE 1015B (denoted as PA in Table 7)) with respect to the total amount were kneaded with a screw rotation speed of 100 rpm in a twin-screw kneader (manufactured by SHIBAURA MACHINE CO., LTD., trade name: TEM-26SS) to obtain resin pellets. The flat cross-section glass fiber has an E glass composition and has a minor axis of 7.0 μm, a major axis D of 28.0 μm, and major axis/minor axis of 4.0.

Then, the resin pellets obtained in the present comparative example were used to conduct injection molding in an injection molding apparatus (manufactured by Nissei Plastic Industrial Co. Ltd., trade name: NEX80) at a mold temperature of 90° ° C. and an injection temperature of 270° C. to thereby produce a glass-reinforced resin molded article having a size of 80 mm in length×60 mm in width and a thickness of 2.0 mm.

Then, the glass-reinforced resin molded article produced in the present comparative example was measured for the TD direction shrinkage ratio and the MD direction shrinkage ratio to thereby determine MD direction shrinkage ratio/TD direction shrinkage ratio. TD direction shrinkage ratio/reference shrinkage ratio was also determined by using the TD direction shrinkage ratio of the glass-reinforced resin molded article of Reference Example 7 described below as the reference shrinkage ratio.

Next, for the glass-reinforced resin molded article produced in the present comparative example, in the entirely same manner as in Example 1, the proportion P of the glass-reinforcing material having a length in the range of 50 to 100 μm with respect to the total number of the glass-reinforcing material having a length of 50 μm or more included in the glass-reinforced resin molded article and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 7.

### Comparative Example 11

In the present comparative example, resin pellets were obtained in the entirely same manner as in Comparative Example 10, except that flat cross-section glass fiber having a minor axis of 5.5 μm, a major axis D of 33.0 μm, and major axis/minor axis of 6.0 was used for kneading in a twin-screw kneader with a screw rotation speed of 110 rpm. Then, a glass-reinforced resin molded article was produced in the entirely same manner as in Comparative Example 10, except that the resin pellets obtained in the present comparative example were used.

Next, for the glass-reinforced resin molded article produced in the present comparative example, in the entirely same manner as in Comparative Example 10, MD direction shrinkage ratio/TD direction shrinkage ratio, TD direction shrinkage ratio/reference shrinkage ratio, the proportion P of the glass-reinforcing material having a length in the range of 50 to 100 μm with respect to the total number of the glass-reinforcing material having a length of 50 μm or more included in the glass-reinforced resin molded article, and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 7.

### Reference Example 7

In the present reference example, resin pellets were obtained in the entirely same manner as in Comparative Example 10, except that, as a glass-reinforcing material, circular cross-section glass fiber having a diameter of 11.0 μm was used for kneading in a twin-screw kneader with a screw rotation speed of 100 rpm.

Then, a glass-reinforced resin molded article was produced in the entirely same manner as in Comparative Example 10, except that the resin pellets obtained in the present reference example were used.

Then, for the glass-reinforced resin molded article produced in the present reference example, the MID direction shrinkage ratio, the TD direction shrinkage ratio, and MD direction shrinkage ratio/TD direction shrinkage ratio were determined in the entirely same manner as in Comparative Example 10, and the TD direction shrinkage ratio was used as the reference shrinkage ratio for Comparative Examples 10 to 11. The results are shown in Table 7.

### Example 16

In the present example, first, as a glass-reinforcing material, 70.0% by mass of flat cross-section glass fiber with respect to the total amount, and as a thermoplastic resin, 30.0% by mass of polyetheretherketone (manufactured by Daicel-Evonik Co., Ltd., trade name: VESTAKEEP 2000G (denoted as PEEK in Table 8)) with respect to the total amount were kneaded with a screw rotation speed of 120 rpm in a twin-screw kneader (manufactured by SHIBAURA MACHINE CO., LTD., trade name: TEM-26SS) to obtain resin pellets. The flat cross-section glass fiber has an E glass composition and has a minor axis of 5.5 μm, a major axis D of 33.0 μm, and major axis/minor axis of 6.0.

Then, the resin pellets obtained in the present example were used to conduct injection molding in an injection molding apparatus (manufactured by Nissei Plastic Industrial Co. Ltd., trade name: NEX80) at a mold temperature of 200° ° C. and an injection temperature of 410° ° C. to thereby produce a glass-reinforced resin molded article having a size of 80 mm in length×60 mm in width and a thickness of 2.0 mm.

Then, the glass-reinforced resin molded article produced in the present example was measured for the TD direction shrinkage ratio and the MD direction shrinkage ratio to thereby determine MD direction shrinkage ratio/TD direction shrinkage ratio. TD direction shrinkage ratio/reference shrinkage ratio was also determined by using the TD direction shrinkage ratio of the glass-reinforced resin molded article of Reference Example 8 described below as the reference shrinkage ratio.

Next, for the glass-reinforced resin molded article produced in the present example, in the entirely same manner as in Example 1, the proportion P of the glass-reinforcing material having a length in the range of 50 to 100 μm with respect to the total number of the glass-reinforcing material having a length of 50 μm or more included in the glass-reinforced resin molded article and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 8.

### Comparative Example 12

In the present comparative example, resin pellets were obtained in the entirely same manner as in Example 16, except that flat cross-section glass fiber having a minor axis of 7.0 μm, a major axis D of 28.0 μm, and major axis/minor axis of 4.0 was used for kneading in a twin-screw kneader with a screw rotation speed of 120 rpm.

Then, a glass-reinforced resin molded article was produced in the entirely same manner as in Example 16, except that the resin pellets obtained in the present comparative example were used.

Next, for the glass-reinforced resin molded article produced in the present comparative example, in the entirely same manner as in Example 16, MD direction shrinkage ratio/TD direction shrinkage ratio, TD direction shrinkage ratio/reference shrinkage ratio, the proportion P of the glass-reinforcing material having a length in the range of 50 to 100 μm with respect to the total number of the glass-reinforcing material having a length of 50 μm or more included in the glass-reinforced resin molded article, and the proportion of the glass-reinforcing material having a length in the range of 25 to 100 μm with respect to the total number of the glass-reinforcing material having a length of 25 μm or more included in the glass-reinforced resin molded article were determined. From the content C of the flat cross-section glass fiber with respect to the total amount of the glass-reinforced resin molded article, the major axis D of the flat cross-section glass fiber, and the proportion P of the glass-reinforcing material having a length in the range of 50 to 100 μm with respect to the total number of the glass-reinforcing material having a length of 50 μm or more included in the glass-reinforced resin molded article, the value of P/(C×D)^{1/2} was determined. The results are shown in Table 8.

### Reference Example 8

In the present reference example, resin pellets were obtained in the entirely same manner as in Example 16, except that, as a glass-reinforcing material, circular cross-section glass fiber having a diameter of 11.0 μm was used for kneading in a twin-screw kneader with a screw rotation speed of 120 rpm.

Then, a glass-reinforced resin molded article was produced in the entirely same manner as in Example 16, except that the resin pellets obtained in the present reference example were used.

Then, for the glass-reinforced resin molded article produced in the present reference example, the MD direction shrinkage ratio, the TD direction shrinkage ratio, and MD direction shrinkage ratio/TD direction shrinkage ratio were determined in the entirely same manner as in Example 16, and the TD direction shrinkage ratio was used as the reference shrinkage ratio for Example 16 and Comparative Example 12. The results are shown in Table 8.

TABLE 1

| | | | | | | | | Reference |
|---|---|---|---|---|---|---|---|---|
| | | | Example 1 | Example 2 | Example 3 | Example 4 | Example 5 | Example 1 |
| Thermoplastic resin | | Type | PC | PC | PC | PC | PC | PC |
| | | Content in glass-reinforced resin molded | 70.0 | 70.0 | 70.0 | 70.0 | 70.0 | 70.0 |
| | | article (% by mass) | | | | | | |
| Glass- | Flat cross-section | Minor axis (μm) | 5.5 | 7.0 | 11.0 | 5.5 | 5.5 | 11.0 |
| reinforcing | glass fiber | Major axis D (μm) | 33.0 | 42.0 | 44.0 | 33.0 | 33.0 | 11.0 |
| material | | Major axis/Minor axis | 6.0 | 6.0 | 4.0 | 6.0 | 6.0 | 1.0 |
| | | Content C of glass-reinforcing material in | 30.0 | 30.0 | 30.0 | 28.0 | 24.0 | 30.0 |
| | | glass-reinforced resin molded article (% by | | | | | | |
| | | mass) | | | | | | |
| | Glass flake | Content in glass-reinforced resin molded | 0.0 | 0.0 | 0.0 | 2.0 | 6.0 | 0.0 |
| | | article (% by mass) | | | | | | |

| | | | | | | |
|---|---|---|---|---|---|---|
| Content of glass-reinforcing material in glass-reinforced resin molded | 30.0 | 30.0 | 30.0 | 30.0 | 30.0 | 30.0 |
| article (% by mass) | | | | | | |
| Screw rotation speed during kneading of thermoplastic resin and glass- | 110 | 100 | 200 | 110 | 110 | 100 |
| reinforcing material (rpm) | | | | | | |
| Proportion P of glass-reinforcing material of 50 to 100 μm in length (%) | 20 | 22 | 19 | 23 | 22 | — |
| Proportion of glass-reinforcing material having length of 25 to 100 μm with | 40 | 45 | 32 | — | — | — |
| respect to total number of glass-reinforcing material having length of 25 μm | | | | | | |
| or more (%) | | | | | | |
| P/(C × D)^{1/2} | 0.64 | 0.62 | 0.52 | 0.76 | 0.78 | — |
| TD direction shrinkage ratio | 0.30 | 0.30 | 0.32 | 0.32 | 0.35 | 0.52 |
| MD direction shrinkage ratio | 0.17 | 0.17 | 0.18 | 0.17 | 0.20 | 0.18 |
| MD direction shrinkage ratio/TD direction shrinkage ratio | 0.57 | 0.57 | 0.56 | 0.53 | 0.57 | 0.35 |
| TD direction shrinkage ratio/reference shrinkage ratio | 0.58 | 0.58 | 0.62 | 0.62 | 0.67 | — |

TABLE 2

| | | | Comparative | Comparative | Comparative | Comparative | Reference |
|---|---|---|---|---|---|---|---|
| | | | Example 1 | Example 2 | Example 3 | Example 4 | Example 1 |
| Thermoplastic resin | | Type | PC | PC | PC | PC | PC |
| | | Content in glass-reinforced resin molded | 70.0 | 70.0 | 70.0 | 70.0 | 70.0 |
| | | article (% by mass) | | | | | |
| Glass- | Flat cross- | Minor axis (μm) | 7.0 | 11.0 | 5.5 | 7.0 | 11.0 |
| reinforcing | section glass | Major axis D (μm) | 28.0 | 44.0 | 33.0 | 28.0 | 11.0 |
| material | fiber | Major axis/Minor axis | 4.0 | 4.0 | 6.0 | 4.0 | 1.0 |
| | | Content C of glass-reinforcing material in glass- | 30.0 | 30.0 | 10.0 | 10.0 | 30.0 |
| | | reinforced resin molded article (% by mass) | | | | | |
| | Glass flake | Content in glass-reinforced resin molded | 0.0 | 0.0 | 20.0 | 20.0 | 0.0 |
| | | article (% by mass) | | | | | |

| | | | | | |
|---|---|---|---|---|---|
| Content of glass-reinforcing material in glass-reinforced resin molded | 30.0 | 30.0 | 30.0 | 30.0 | 30.0 |
| article (% by mass) | | | | | |
| Screw rotation speed during kneading of thermoplastic resin and glass- | 100 | 100 | 110 | 100 | 100 |
| reinforcing material (rpm) | | | | | |
| Proportion P of glass-reinforcing material of 50 to 100 μm in length (%) | 13 | 11 | 22 | 20 | — |
| Proportion of glass-reinforcing material having length of 25 to 100 μm with | 23 | 26 | — | — | — |
| respect to total number of glass-reinforcing material having length of 25 μm | | | | | |
| or more (%) | | | | | |
| P/(C × D)^{1/2} | 0.45 | 0.30 | 1.21 | 1.20 | — |
| TD direction shrinkage ratio | 0.38 | 0.39 | 0.61 | 0.59 | 0.52 |
| MD direction shrinkage ratio | 0.17 | 0.17 | 0.44 | 0.46 | 0.18 |
| MD direction shrinkage ratio/TD direction shrinkage ratio | 0.45 | 0.44 | 0.72 | 0.78 | 0.35 |
| TD direction shrinkage ratio/reference shrinkage ratio | 0.73 | 0.75 | 1.17 | 1.13 | — |

TABLE 3

| | | | Example | Example | Reference | Comparative | Comparative | Reference |
|---|---|---|---|---|---|---|---|---|
| | | | 6 | 7 | Example 2 | Example 5 | Example 6 | Example 3 |
| Thermoplastic resin | | Type | PC | PC | PC | PC | PC | PC |
| | | Content in glass-reinforced resin | 60.0 | 60.0 | 60.0 | 80.0 | 80.0 | 80.0 |
| | | molded article (% by mass) | | | | | | |
| Glass- | Flat cross- | Minor axis (μm) | 5.5 | 7.0 | 11.0 | 7.0 | 5.5 | 11.0 |
| reinforcing | section glass | Major axis D (μm) | 33.0 | 42.0 | 11.0 | 28.0 | 33.0 | 11.0 |
| material | fiber | Major axis/Minor axis | 6.0 | 6.0 | 1.0 | 4.0 | 6.0 | 1.0 |
| | | Content C of glass-reinforcing | 40.0 | 40.0 | 40.0 | 20.0 | 20.0 | 20.0 |
| | | material in glass-reinforced resin | | | | | | |
| | | molded article (% by mass) | | | | | | |
| | Glass flake | Content in glass-reinforced resin | 0.0 | 0.0 | 0.0 | 0.0 | 0.0 | 0.0 |
| | | molded article (% by mass) | | | | | | |

| | | | | | | |
|---|---|---|---|---|---|---|
| Content of glass-reinforcing material in glass-reinforced resin molded | 40.0 | 40.0 | 40.0 | 20.0 | 20.0 | 20.0 |
| article (% by mass) | | | | | | |
| Screw rotation speed during kneading of thermoplastic resin and glass- | 110 | 100 | 100 | 100 | 110 | 100 |
| reinforcing material (rpm) | | | | | | |
| Proportion P of glass-reinforcing material of 50 to 100 μm in length (%) | 24 | 26 | — | 8 | 11 | — |
| Proportion of glass-reinforcing material having length of 25 to 100 μm | 47 | 51 | — | 17 | 26 | — |
| with respect to total number of glass-reinforcing material having length | | | | | | |
| of 25 μm or more (%) | | | | | | |
| P/(C × D)^{1/2} | 0.66 | 0.63 | — | 0.34 | 0.43 | — |
| TD direction shrinkage ratio | 0.26 | 0.26 | 0.49 | 0.45 | 0.45 | 0.56 |
| MD direction shrinkage ratio | 0.15 | 0.15 | 0.18 | 0.20 | 0.20 | 0.21 |
| MD direction shrinkage ratio/TD direction shrinkage ratio | 0.58 | 0.58 | 0.37 | 0.44 | 0.44 | 0.38 |
| TD direction shrinkage ratio/reference shrinkage ratio | 0.53 | 0.53 | — | 0.80 | 0.80 | — |

TABLE 4

| | | | Example | Example | Example | Comparative | Comparative | Reference |
|---|---|---|---|---|---|---|---|---|
| | | | 8 | 9 | 10 | Example 7 | Example 8 | Example 4 |
| Thermoplastic resin | | Type | PBT | PBT | PBT | PBT | PBT | PBT |
| | | Content in glass-reinforced resin | 70.0 | 70.0 | 70.0 | 70.0 | 70.0 | 70.0 |
| | | molded article (% by mass) | | | | | | |
| Glass- | Flat cross- | Minor axis (μm) | 5.5 | 7.0 | 11.0 | 7.0 | 11.0 | 11.0 |
| reinforcing | section glass | Major axis D (μm) | 33.0 | 42.0 | 44.0 | 28.0 | 44.0 | 11.0 |
| material | fiber | Major axis/Minor axis | 6.0 | 6.0 | 4.0 | 4.0 | 4.0 | 1.0 |
| | | Content C of glass-reinforcing | 30.0 | 30.0 | 30.0 | 30.0 | 30.0 | 30.0 |
| | | material in glass-reinforced resin | | | | | | |
| | | molded article (% by mass) | | | | | | |
| | Glass flake | Content in glass-reinforced resin | 0.0 | 0.0 | 0.0 | 0.0 | 0.0 | 0.0 |
| | | molded article (% by mass) | | | | | | |

| | | | | | | |
|---|---|---|---|---|---|---|
| Content of glass-reinforcing material in glass-reinforced resin molded | 30.0 | 30.0 | 30.0 | 30.0 | 30.0 | 30.0 |
| article (% by mass) | | | | | | |
| Screw rotation speed during kneading of thermoplastic resin and glass- | 110 | 100 | 200 | 100 | 100 | 100 |
| reinforcing material (rpm) | | | | | | |
| Proportion P of glass-reinforcing material of 50 to 100 μm in length (%) | 24 | 28 | 17 | 7 | 10 | — |
| Proportion of glass-reinforcing material having length of 25 to 100 μm | 37 | 40 | 33 | 20 | 24 | — |
| with respect to total number of glass-reinforcing material having length | | | | | | |
| of 25 μm or more (%) | | | | | | |
| P/(C × D)^{1/2} | 0.76 | 0.79 | 0.47 | 0.24 | 0.28 | — |
| TD direction shrinkage ratio | 0.93 | 0.93 | 0.84 | 1.00 | 1.00 | 1.35 |
| MD direction shrinkage ratio | 0.47 | 0.48 | 0.47 | 0.48 | 0.48 | 0.50 |
| MD direction shrinkage ratio/TD direction shrinkage ratio | 0.51 | 0.52 | 0.56 | 0.48 | 0.48 | 0.37 |
| TD direction shrinkage ratio/reference shrinkage ratio | 0.69 | 0.69 | 0.62 | 0.74 | 0.74 | — |

TABLE 5

| | | | | | Comparative | Reference |
|---|---|---|---|---|---|---|
| | | | Example 11 | Example 12 | Example 9 | Example 5 |
| Thermoplastic resin | | Type | PBT | PBT | PBT | PBT |
| | | Content in glass-reinforced resin molded article (% by mass) | 60.0 | 60.0 | 60.0 | 60.0 |
| Glass- | Flat cross- | Minor axis (μm) | 5.5 | 7.0 | 7.0 | 11.0 |
| reinforcing | section glass | Major axis D (μm) | 33.0 | 42.0 | 28.0 | 11.0 |
| material | fiber | Major axis/Minor axis | 6.0 | 6.0 | 4.0 | 1.0 |
| | | Content C of glass-reinforcing material in glass-reinforced resin | 40.0 | 40.0 | 40.0 | 40.0 |
| | | molded article (% by mass) | | | | |
| | Glass flake | Content in glass-reinforced resin molded article (% by mass) | 0.0 | 0.0 | 0.0 | 0.0 |

| | | | | |
|---|---|---|---|---|
| Content of glass-reinforcing material in glass-reinforced resin molded article (% by mass) | 40.0 | 40.0 | 40.0 | 40.0 |
| Screw rotation speed during kneading of thermoplastic resin and glass-reinforcing material | 110 | 100 | 100 | 100 |
| (rpm) | | | | |
| Proportion P of glass-reinforcing material of 50 to 100 μm in length (%) | 28 | 31 | 13 | — |
| Proportion of glass-reinforcing material having length of 25 to 100 μm with respect to total | 44 | 48 | 26 | — |
| number of glass-reinforcing material having length of 25 μm or more (%) | | | | |
| P/(C × D)^{1/2} | 0.77 | 0.76 | 0.39 | — |
| TD direction shrinkage ratio | 0.81 | 0.83 | 0.92 | 1.30 |
| MD direction shrinkage ratio | 0.42 | 0.42 | 0.43 | 0.46 |
| MD direction shrinkage ratio/TD direction shrinkage ratio | 0.52 | 0.51 | 0.47 | 0.35 |
| TD direction shrinkage ratio/reference shrinkage ratio | 0.62 | 0.64 | 0.71 | — |

TABLE 6

| | | | Example | Example | Example | Reference |
|---|---|---|---|---|---|---|
| | | | 13 | 14 | 15 | Example 6 |
| Thermoplastic resin | | Type | PA | PA | PA | PA |
| | | Content in glass-reinforced | 40.0 | 40.0 | 40.0 | 40.0 |
| | | resin molded article (% by | | | | |
| | | mass) | | | | |
| Glass- | Flat | Minor axis (μm) | 7.0 | 5.5 | 11.0 | 11.0 |
| reinforcing | cross- | Major axis D (μm) | 42.0 | 33.0 | 44.0 | 11.0 |
| material | section | Major axis/Minor axis | 6.0 | 6.0 | 4.0 | 1.0 |
| | glass | Content C of glass-reinforcing | 60.0 | 60.0 | 60.0 | 60.0 |
| | fiber | material in glass-reinforced | | | | |
| | | resin molded article (% by | | | | |
| | | mass) | | | | |
| | Glass | Content in glass-reinforced | 0.0 | 0.0 | 0.0 | 0.0 |
| | flake | resin molded article (% by | | | | |
| | | mass) | | | | |

| | | | | |
|---|---|---|---|---|
| Content of glass-reinforcing material in glass- | 60.0 | 60.0 | 60.0 | 60.0 |
| reinforced resin molded article (% by mass) | | | | |
| Screw rotation speed during kneading of | 100 | 110 | 130 | 100 |
| thermoplastic resin and glass-reinforcing material | | | | |
| (rpm) | | | | |
| Proportion P of glass-reinforcing material of 50 to | 34 | 28 | 29 | — |
| 100 μm in length (%) | | | | |
| Proportion of glass-reinforcing material having | 50 | 46 | 49 | — |
| length of 25 to 100 μm with respect to total | | | | |
| number of glass-reinforcing material having length | | | | |
| of 25 μm or more (%) | | | | |
| P/(C × D)^{1/2} | 0.68 | 0.63 | 0.56 | — |
| TD DIRECTION SHRINKAGE RATIO | 0.40 | 0.38 | 0.41 | 0.90 |
| MD direction shrinkage ratio | 0.26 | 0.25 | 0.25 | 0.31 |
| MD direction shrinkage ratio/TD direction | 0.65 | 0.66 | 0.61 | 0.34 |
| shrinkage ratio | | | | |
| TD direction shrinkage ratio/reference shrinkage | 0.44 | 0.42 | 0.46 | — |
| ratio | | | | |

TABLE 7

| | | | Comparative | Comparative | Reference |
|---|---|---|---|---|---|
| | | | Example 10 | Example 11 | Example 7 |
| Thermoplastic resin | | Type | PA | PA | PA |
| | | Content in glass-reinforced resin molded | 70.0 | 70.0 | 70.0 |
| | | article (% by mass) | | | |
| Glass- | Flat cross- | Minor axis (μm) | 7.0 | 5.5 | 11.0 |
| reinforcing | section glass | Major axis D (μm) | 28.0 | 33.0 | 11.0 |
| material | fiber | Major axis/Minor axis | 4.0 | 6.0 | 1.0 |
| | | Content C of glass-reinforcing material in glass- | 30.0 | 30.0 | 30.0 |
| | | reinforced resin molded article (% by mass) | | | |
| | Glass flake | Content in glass-reinforced resin molded | 0.0 | 0.0 | 0.0 |
| | | article (% by mass) | | | |

| | | | |
|---|---|---|---|
| Content of glass-reinforcing material in glass-reinforced resin molded | 30.0 | 30.0 | 30.0 |
| article (% by mass) | | | |
| Screw rotation speed during kneading of thermoplastic resin and glass- | 100 | 110 | 100 |
| reinforcing material (rpm) | | | |
| Proportion P of glass-reinforcing material of 50 to 100 μm in length (%) | 5 | 12 | — |
| Proportion of glass-reinforcing material having length of 25 to 100 μm with | 8 | 19 | — |
| respect to total number of glass-reinforcing material having length of 25 μm | | | |
| or more (%) | | | |
| P/(C × D)^{1/2} | 0.17 | 0.38 | — |
| TD direction shrinkage ratio | 0.70 | 0.69 | 0.82 |
| MD direction shrinkage ratio | 0.35 | 0.36 | 0.37 |
| MD direction shrinkage ratio/TD direction shrinkage ratio | 0.50 | 0.52 | 0.45 |
| TD direction shrinkage ratio/reference shrinkage ratio | 0.85 | 0.84 | — |

TABLE 8

| | | | Example | Comparative | Reference |
|---|---|---|---|---|---|
| | | | 16 | Example 12 | Example 8 |
| Thermoplastic resin | | Type | PEEK | PEEK | PEEK |
| | | Content in glass-reinforced resin molded | 70.0 | 70.0 | 70.0 |
| | | article (% by mass) | | | |
| Glass- | Flat cross- | Minor axis (μm) | 5.5 | 7.0 | 11.0 |
| reinforcing | section glass | Major axis D (μm) | 33.0 | 28.0 | 11.0 |
| material | fiber | Major axis/Minor axis | 6.0 | 4.0 | 1.0 |
| | | Content C of glass-reinforcing material in glass- | 30.0 | 30.0 | 30.0 |
| | | reinforced resin molded article (% by mass) | | | |
| | Glass flake | Content in glass-reinforced resin molded | 0.0 | 0.0 | 0.0 |
| | | article (% by mass) | | | |

| | | | |
|---|---|---|---|
| Content of glass-reinforcing material in glass-reinforced resin molded | 30.0 | 30.0 | 30.0 |
| article (% by mass) | | | |
| Screw rotation speed during kneading of thermoplastic resin and glass- | 120 | 120 | 120 |
| reinforcing material (rpm) | | | |
| Proportion P of glass-reinforcing material of 50 to 100 μm in length (%) | 25 | 9 | — |
| Proportion of glass-reinforcing material having length of 25 to 100 μm with | 39 | 28 | — |
| respect to total number of glass-reinforcing material having length of 25 μm | | | |
| or more (%) | | | |
| P/(C × D)^{1/2} | 0.79 | 0.31 | — |
| TD direction shrinkage ratio | 0.69 | 0.80 | 1.10 |
| MD direction shrinkage ratio | 0.53 | 0.51 | 0.52 |
| MD direction shrinkage ratio/TD direction shrinkage ratio | 0.77 | 0.64 | 0.47 |
| TD direction shrinkage ratio/reference shrinkage ratio | 0.63 | 0.73 | — |

As seen in Tables 1 to 8, according to the glass-reinforced resin molded articles of Examples 1 to 16, MD direction shrinkage ratio/TD direction shrinkage ratio is 0.50 or more and thus it is demonstrated that the anisotropy of a shrinkage ratio can be reduced, and TD direction shrinkage ratio/reference shrinkage ratio is less than 0.70 and thus it is demonstrated that the TD direction shrinkage ratio can be reduced.

In contrast, as seen in Tables 1 to 8, according to the glass-reinforced resin molded articles of Comparative Examples 1 to 12, which have a value of P/(C×D)^{1/2} of less than 0.46 or more than 0.99, MD direction shrinkage ratio/TD direction shrinkage ratio is less than 0.50 and thus it is demonstrated that the anisotropy of a shrinkage ratio cannot be reduced, TD direction shrinkage ratio/reference shrinkage ratio is 0.70 or more and thus it is demonstrated that the TD direction shrinkage ratio cannot be reduced, or both.

1. A glass-reinforced resin molded article comprising a glass-reinforcing material in a range of 10.0 to 90.0% by mass with respect to a total amount of the glass-reinforced resin molded article, and a thermoplastic resin,
wherein the glass-reinforcing material comprises flat cross-section glass fiber having a flat cross-sectional shape of which a ratio of a major axis to a minor axis (major axis/minor axis) is in a range of 3.0 to 10.0,
a content C of the flat cross-section glass fiber with respect to the total amount of the glass-reinforced resin molded article is in a range of 10.0 to 80.0% by mass,
the major axis D of the flat cross-section glass fiber is in a range of 25.0 to 55.0 μm,
a proportion P of the glass-reinforcing material having a length in a range of 50 to 100 μm with respect to the total number of the glass-reinforcing material having a length of 50 μm or more included in the glass-reinforced resin molded article is in a range of 4 to 50%, and
the C, D, and P satisfy following formula (1):
0.46≤P/(C×D)^{1/2}≤0.99 (1).

2. The glass-reinforced resin molded article according to claim 1, wherein the C is in a range of 20.0 to 70.0% by mass, the D is in a range of 30.0 to 50.0 μm, the P is in a range of 10 to 40%, and the C, D, and P satisfy following formula (2):
0.54≤P/(C×D)^{1/2}≤0.72 (2).

3. The glass-reinforced resin molded article according to claim 1, wherein the flat cross-section glass fiber comprises a flat cross-sectional shape of which the ratio of the major axis to the minor axis is in a range of 5.0 to 8.0.

4. The glass-reinforced resin molded article according to claim 1, wherein the thermoplastic resin is one thermoplastic resin selected from a group consisting of polycarbonate, polybutylene terephthalate, polyetheretherketone, or polyamide.

5. The glass-reinforced resin molded article according to claim 4, wherein the thermoplastic resin is polycarbonate or polyamide.

6. The glass-reinforced resin molded article according to claim 4, wherein the thermoplastic resin is polyamide.
